(19) United States
(12) Patent Application Publication
(10) Pub. No.: US 2025/0240121 A1
(43) Pub. Date: Jul. 24, 2025

(54) CODE BLOCK BUNDLE-BASED INTERLEAVING FOR FREQUENCY DIVERSITY

(71) Applicant: QUALCOMM Incorporated, San Diego, CA (US)

(72) Inventors: Somsubhra BARIK, SAN DIEGO, CA (US); Jing SUN, San Diego, CA (US); Wei YANG, San Diego, CA (US)

(21) Appl. No.: 18/418,049

(22) Filed: Jan. 19, 2024

(51) Int. Cl. H04L 1/00; H04L 27/26; H04W 8/22; H04W 72/0457; H04W 72/232

(52) U.S. Cl. CPC H04L 1/0071; H04L 27/26025; H04W 8/22; H04W 72/0457; H04W 72/232

(57) ABSTRACT

Methods, systems, and devices for wireless communications are described. The described techniques provide for a network entity performing a first interleaving operation to interleave a quantity of resource elements (REs) of each respective code block of multiple code blocks into a respective cycle of multiple cycles according to a first or second interleaving value. In some examples, the network entity may select the second interleaving value based on a quantity of unavailable REs. The network entity may perform a second interleaving operation to interleave each respective cycle with a quantity of REs corresponding to a second multiple of code blocks. In some examples, the network entity may output an indication of the first or second interleaving value and a downlink message to a user equipment. The user equipment may receive the downlink message, and perform first and second deinterleaving operations according to the first or second interleaving value.

### FIELD OF TECHNOLOGY

The following relates to wireless communications, including code block bundle-based interleaving for frequency diversity.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Some wireless systems may support interleaving of frequency resources to improve wireless communications.

### SUMMARY

The described techniques relate to improved methods, systems, devices, and apparatuses that support code block bundle-based interleaving for frequency diversity. For example, the described techniques provide for a network entity to perform a first interleaving operation to interleave a first quantity of resource elements (REs) of each respective code block of multiple code blocks into a respective cycle of multiple cycles. In some cases, a first quantity of REs may correspond to a first interleaving value. In some examples, the network entity may perform a second interleaving operation to interleave each cycle of the multiple cycles with a second quantity of REs corresponding to a second multiple of code blocks. Based on the first interleaving operation and the second interleaving operation, the network entity may output a downlink message to a UE.

The network entity may select the first interleaving value from multiple candidate interleaving values based on a carrier frequency associated with the downlink message, a bandwidth part associated with the downlink message, a subcarrier spacing associated with the downlink message, or any combination thereof. In some cases, one or more REs of the first quantity of REs may be unavailable. In such cases, the network entity may select a second interleaving value that is less than or equal to the first interleaving value and may interleave a different quantity of REs corresponding to the second interleaving value. In some examples, the network entity may output an indication of the first interleaving value or the second interleaving value, based on which the UE may perform the interleaving. In some cases, the UE may receive the downlink message, and may perform a first deinterleaving operation and a second deinterleaving operation to decode the downlink message according to the first interleaving value or the second interleaving value.

A method for wireless communications by a network entity is described. The method may include performing a first interleaving operation to interleave a first quantity of REs of each respective code block of a set of multiple code blocks into a respective cycle of a set of multiple cycles, the first quantity of REs corresponding to a first interleaving value, performing a second interleaving operation to interleave each cycle of the set of multiple cycles with a second quantity of REs corresponding to a second set of multiple code blocks, and outputting a downlink message based on the first interleaving operation and the second interleaving operation.

A network entity for wireless communications is described. The network entity may include one or more memories storing processor executable code, and one or more processors coupled with the one or more memories. The one or more processors may individually or collectively be operable to execute the code to cause the network entity to perform a first interleaving operation to interleave a first quantity of REs of each respective code block of a set of multiple code blocks into a respective cycle of a set of multiple cycles, the first quantity of REs corresponding to a first interleaving value, perform a second interleaving operation to interleave each cycle of the set of multiple cycles with a second quantity of REs corresponding to a second set of multiple code blocks, and output a downlink message based on the first interleaving operation and the second interleaving operation.

Another network entity for wireless communications is described. The network entity may include means for performing a first interleaving operation to interleave a first quantity of REs of each respective code block of a set of multiple code blocks into a respective cycle of a set of multiple cycles, the first quantity of REs corresponding to a first interleaving value, means for performing a second interleaving operation to interleave each cycle of the set of multiple cycles with a second quantity of REs corresponding to a second set of multiple code blocks, and means for outputting a downlink message based on the first interleaving operation and the second interleaving operation.

A non-transitory computer-readable medium storing code for wireless communications is described. The code may include instructions executable by one or more processors to perform a first interleaving operation to interleave a first quantity of REs of each respective code block of a set of multiple code blocks into a respective cycle of a set of multiple cycles, the first quantity of REs corresponding to a first interleaving value, perform a second interleaving operation to interleave each cycle of the set of multiple cycles with a second quantity of REs corresponding to a second set of multiple code blocks, and output a downlink message based on the first interleaving operation and the second interleaving operation.

Some examples of the method, network entities, and non-transitory computer-readable medium described herein may further include operations, features, means, or instructions for outputting an indication of the first interleaving value, where outputting the downlink message may be based on outputting the indication of the first interleaving value.

In some examples of the method, network entities, and non-transitory computer-readable medium described herein, outputting the indication of the first interleaving value may include operations, features, means, or instructions for selecting the first interleaving value from a set of multiple candidate interleaving values based on one or more of: a carrier frequency associated with the downlink message, a bandwidth part associated with the downlink message, a subcarrier spacing associated with the downlink message, or any combination thereof.

Some examples of the method, network entities, and non-transitory computer-readable medium described herein may further include operations, features, means, or instructions for obtaining capability information indicating that a UE supports the first interleaving operation and outputting control signaling enabling the first interleaving operation based on obtaining the capability information, where performing the first interleaving operation and outputting the downlink message may be based on outputting the control signaling enabling the first interleaving operation.

In some examples of the method, network entities, and non-transitory computer-readable medium described herein, the capability information includes an indication of a first threshold quantity of code blocks supported by the UE for deinterleaving the downlink message according to a deinterleaving operation corresponding to the first interleaving operation and enabling the first interleaving operation may be based on the first quantity of supported code blocks satisfying a threshold.

In some examples of the method, network entities, and non-transitory computer-readable medium described herein, the set of multiple code blocks may be based on the capability information and a quantity of the set of multiple code blocks satisfies the first threshold quantity of code blocks.

Some examples of the method, network entities, and non-transitory computer-readable medium described herein may further include operations, features, means, or instructions for estimating downlink channel state information for the downlink message and enabling the first interleaving operation based on a channel rank, a modulation and coding scheme, or both, associated with the estimated downlink channel state information.

Some examples of the method, network entities, and non-transitory computer-readable medium described herein may further include operations, features, means, or instructions for obtaining a request to perform the first interleaving operation based on a threshold delay spread associated with an estimated delay spread, where performing the first interleaving operation may be based on the request.

Some examples of the method, network entities, and non-transitory computer-readable medium described herein may further include operations, features, means, or instructions for performing the first interleaving operation may be based on a bandwidth allocation associated with the downlink message.

Some examples of the method, network entities, and non-transitory computer-readable medium described herein may further include operations, features, means, or instructions for selecting a second interleaving value based on one or more unavailable REs of the first quantity of REs, the second interleaving value being lower than the first interleaving value and performing a third interleaving operation to interleave a third quantity of REs, the third quantity of REs corresponding to the second interleaving value, where each cycle of the set of multiple cycles may be based on the third interleaving operation.

Some examples of the method, network entities, and non-transitory computer-readable medium described herein may further include operations, features, means, or instructions for selecting a second interleaving value based on one or more unavailable REs of the first quantity of REs, the second interleaving value equal to the first interleaving value and performing a third interleaving operation to interleave a third quantity of REs, the third quantity of REs corresponding to the second interleaving value, where each cycle of the set of multiple cycles may be based on the third interleaving operation.

A method for wireless communications by a UE is described. The method may include obtaining a downlink message, performing a first deinterleaving operation to deinterleave the downlink message into a set of multiple cycles, performing a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value, and decoding the downlink message based on the first deinterleaving operation and the second deinterleaving operation.

A UE for wireless communications is described. The UE may include one or more memories storing processor executable code, and one or more processors coupled with the one or more memories. The one or more processors may individually or collectively be operable to execute the code to cause the UE to obtain a downlink message, perform a first deinterleaving operation to deinterleave the downlink message into a set of multiple cycles, perform a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value, and decode the downlink message based on the first deinterleaving operation and the second deinterleaving operation.

Another UE for wireless communications is described. The UE may include means for obtaining a downlink message, means for performing a first deinterleaving operation to deinterleave the downlink message into a set of multiple cycles, means for performing a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value, and means for decoding the downlink message based on the first deinterleaving operation and the second deinterleaving operation.

A non-transitory computer-readable medium storing code for wireless communications is described. The code may include instructions executable by one or more processors to obtain a downlink message, perform a first deinterleaving operation to deinterleave the downlink message into a set of multiple cycles, perform a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value, and decode the downlink message based on the first deinterleaving operation and the second deinterleaving operation.

Some examples of the method, UEs, and non-transitory computer-readable medium described herein may further include operations, features, means, or instructions for obtaining an indication of the first interleaving value, where performing the second deinterleaving operation may be based on obtaining the indication of the first interleaving value.

Some examples of the method, UEs, and non-transitory computer-readable medium described herein may further include operations, features, means, or instructions for outputting capability information indicating that the UE supports the second deinterleaving operation and obtaining control signaling enabling the second deinterleaving operation based on outputting the capability information, where obtaining the downlink message and performing the second deinterleaving operation may be based on obtaining the control signaling enabling the second deinterleaving operation.

In some examples of the method, UEs, and non-transitory computer-readable medium described herein, the capability information includes an indication of a first threshold quantity of code blocks supported by the UE for deinterleaving the downlink message according to the second deinterleaving operation and enabling the second deinterleaving operation may be based on the first quantity of supported code blocks satisfying a threshold.

Some examples of the method, UEs, and non-transitory computer-readable medium described herein may further include operations, features, means, or instructions for obtaining control signaling enabling the second deinterleaving operation based on a channel rank, a modulation and coding scheme, or both, associated with an estimated downlink channel state information.

Some examples of the method, UEs, and non-transitory computer-readable medium described herein may further include operations, features, means, or instructions for communicating, via radio resource control signaling or downlink control information signaling, an indication of a threshold quantity of code blocks for the second deinterleaving operation, where performing the second deinterleaving operation may be based on the set of multiple code blocks satisfying the threshold quantity of code blocks.

Some examples of the method, UEs, and non-transitory computer-readable medium described herein may further include operations, features, means, or instructions for outputting a request for the downlink message according to an interleaving operation corresponding to the second deinterleaving operation based on a threshold delay spread associated with an estimated delay spread, where performing the second deinterleaving operation may be based on outputting the request.

Some examples of the method, UEs, and non-transitory computer-readable medium described herein may further include operations, features, means, or instructions for obtaining control signaling enabling the second deinterleaving operation, where performing the second deinterleaving operation may be based on a bandwidth allocation associated with the downlink message.

Some examples of the method, UEs, and non-transitory computer-readable medium described herein may further include operations, features, means, or instructions for performing a third deinterleaving operation to deinterleave the set of multiple code blocks according to a second interleaving value that may be lower than the first interleaving value, where each cycle of the set of multiple cycles may be based on the third deinterleaving operation.

Some examples of the method, UEs, and non-transitory computer-readable medium described herein may further include operations, features, means, or instructions for performing a third deinterleaving operation to deinterleave the set of multiple code blocks according to a second interleaving value equal to the first interleaving value, where each cycle of the set of multiple cycles may be based on the third deinterleaving operation.

### BRIEF DESCRIPTION OF THE DRAWINGS

FIGS. 1 and 2 show examples of wireless communications systems that support code block bundle-based interleaving for frequency diversity in accordance with one or more aspects of the present disclosure.

FIGS. 3 and 4 show examples of frequency domain interleaving operations that support code block bundle-based interleaving for frequency diversity in accordance with one or more aspects of the present disclosure.

FIG. 5 shows an example of a process flow that supports code block bundle-based interleaving for frequency diversity in accordance with one or more aspects of the present disclosure.

FIGS. 6 and 7 show block diagrams of devices that support code block bundle-based interleaving for frequency diversity in accordance with one or more aspects of the present disclosure.

FIG. 8 shows a block diagram of a communications manager that supports code block bundle-based interleaving for frequency diversity in accordance with one or more aspects of the present disclosure.

FIG. 9 shows a diagram of a system including a device that supports code block bundle-based interleaving for frequency diversity in accordance with one or more aspects of the present disclosure.

FIGS. 10 and 11 show block diagrams of devices that support code block bundle-based interleaving for frequency diversity in accordance with one or more aspects of the present disclosure.

FIG. 12 shows a block diagram of a communications manager that supports code block bundle-based interleaving for frequency diversity in accordance with one or more aspects of the present disclosure.

FIG. 13 shows a diagram of a system including a device that supports code block bundle-based interleaving for frequency diversity in accordance with one or more aspects of the present disclosure.

FIGS. 14 through 16 show flowcharts illustrating methods that support code block bundle-based interleaving for frequency diversity in accordance with one or more aspects of the present disclosure.

### DETAILED DESCRIPTION

In some wireless communications systems, a block interleaver (row in/column out) may interleave frequency resources with different resource block (RB) bundle sizes. However, while lower bundle size (e.g., 2 or 4 RBs) may support more interleaving gain, channel estimation on a basis of physical resource group (PRG) level granularity may restrict a granularity of the bundle size (e.g., a lowest size) that a wireless device may use in the block interleaver. In some cases, a code block may be divided into interleavable chunks of smaller size. In such cases, a diversity level of resource element (RE) level interleaving may be limited by the code block size (e.g., in a quantity of tones). Additionally, smaller code blocks may have less frequency diversity to begin with (e.g., smaller code blocks span a shorter range of frequencies).

The wireless communications system, according to techniques described herein, may support an increase in the effective diversity level of code blocks beyond the quantity of PRGs in a code block using an additional interleaving step apart from PRG level interleaving (e.g., virtual resource block (VRB) to physical resource block (PRB) mapping or subband rate matching). In some examples, a network entity may perform code block bundle-based interleaving. For example, the network entity may group multiple code blocks into one or more code block bundles and interleave REs of each code block bundle into one or more cycles according to a first interleaving value, K (e.g., in a round-robin fashion). The interleaving value, K, may denote a quantity of REs taken from each code block in a code block bundle and placed into a corresponding cycle such that each cycle of the one or more cycles include one or more sets of K REs from each of the code blocks in the code block bundle. In some cases, a quantity of cycles may correspond to a quotient of a code block size in REs (e.g., the size of a code block in a code block bundle) and the first interleaving value. In some examples, the network entity may interleave the code block bundles based on obtaining capability information from a user equipment (UE) indicating that the UE supports the code block bundle-based interleaving.

In some cases, the network entity may select the first interleaving value from a set of interleaving values based on a per-carrier frequency, bandwidth part, subcarrier spacing, or any combination thereof. In some cases, one or more REs may not be available on a symbol during the code block bundle-based interleaving. In such cases, the network entity may rate match data around the one or more unavailable REs according to a second interleaving value less than or equal to the first interleaving value. In some examples, the network entity may output an indication of the first interleaving value or the second interleaving value to the UE. In some cases, the UE may deinterleave a downlink message obtained from the network entity according to the indication of the first interleaving value or the second interleaving value. For example, the UE may perform a first deinterleaving operation to deinterleave the second interleaving operation and a second deinterleaving operation to deinterleave the first interleaving operation. In some aspects, the UE may perform the second deinterleaving operation based on receiving the indication of the first interleaving value or the second interleaving value.

Aspects of the disclosure are initially described in the context of wireless communications systems. Aspects of the disclosure are further illustrated by and described with reference to frequency domain interleaving operations and a process flow. Aspects of the disclosure are further illustrated by and described with reference to apparatus diagrams, system diagrams, and flowcharts that relate to code block bundle-based interleaving for frequency diversity.

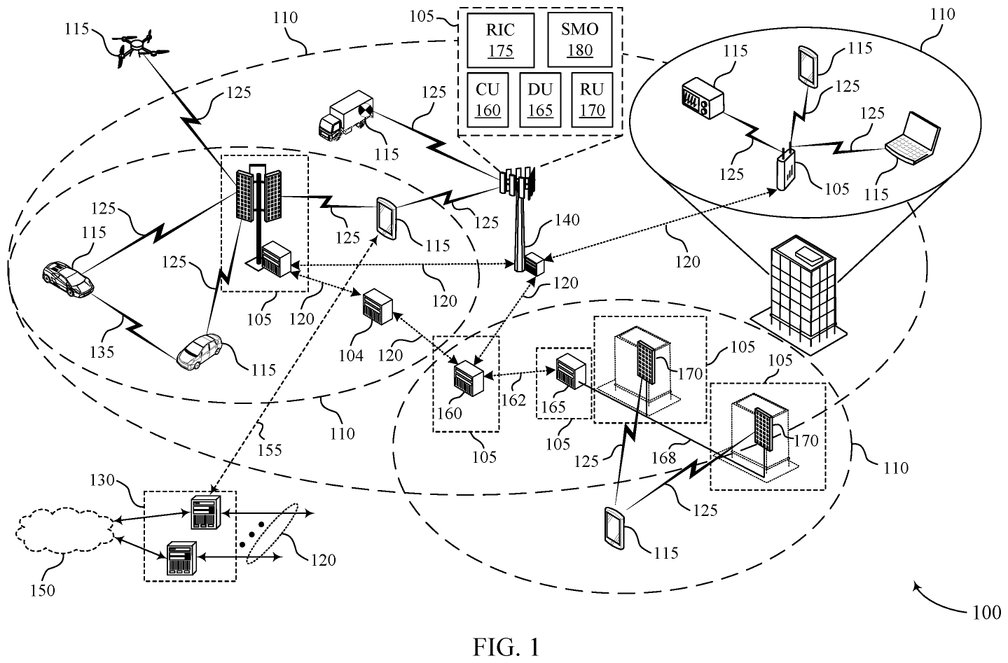

FIG. 1 shows an example of a wireless communications system 100 that supports code block bundle-based interleaving for frequency diversity in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support code block bundle-based interleaving for frequency diversity as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a RE may refer to resources of one symbol period (e.g., a duration of one modulation symbol) and one subcarrier, in which case the symbol period and subcarrier spacing may be inversely related. The quantity of bits carried by each RE may depend on the modulation scheme (e.g., the order of the modulation scheme, the coding rate of the modulation scheme, or both), such that a relatively higher quantity of REs (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications systems 100, a block interleaver (row in/column out) may interleave frequency resources with different RB bundle sizes (e.g., 2 or 4 RB bundles with an interleaving depth of 2). However, while lower bundle size may support more interleaving gain, channel estimation on a basis of PRG level granularity may restrict a granularity of the bundle size (e.g., the lowest) that a wireless device may use in such interleavers. In some cases, a code block may be divided into interleavable chunks of smaller size. In such cases, a diversity level of RE level interleaving may be limited by the code block size (e.g., in a quantity of tones). Additionally, smaller code blocks may have less frequency diversity to begin with (e.g., smaller code blocks span a shorter range of frequencies).

The wireless communications system 100 may support an increase in the effective diversity level of code blocks beyond the quantity of PRGs in the code block using an additional interleaving step apart from PRG level interleaving (e.g., VRB-to-PRB mapping or subband rate matching). In some examples, the network entity 105 may perform code block bundle-based interleaving. For example, the network entity 105 may group code blocks into bundles of N code blocks and rate match in an interleaved manner within each bundle according to a first interleaving value denoting a quantity of REs. In some examples, the network entity 105 may interleave the code block bundles based on obtaining capability information from the UE 115 indicating that the UE 115 supports the code block bundle-based interleaving.

In some cases, the network entity 105 may select the first interleaving value from a set of interleaving values based on a per-carrier frequency, bandwidth part, subcarrier spacing, or any combination thereof. In some cases, one or more REs may not be available on a symbol during the code block bundle-based interleaving. In such cases, the network entity 105 may rate match data around the one or more unavailable REs according to a second interleaving value less than or equal to the first interleaving value. In some examples, the network entity 105 may output an indication of the first interleaving value or the second interleaving value to the UE 115. In some cases, the UE 115 may deinterleave a downlink message according to the indication of the first interleaving value or the second interleaving value.

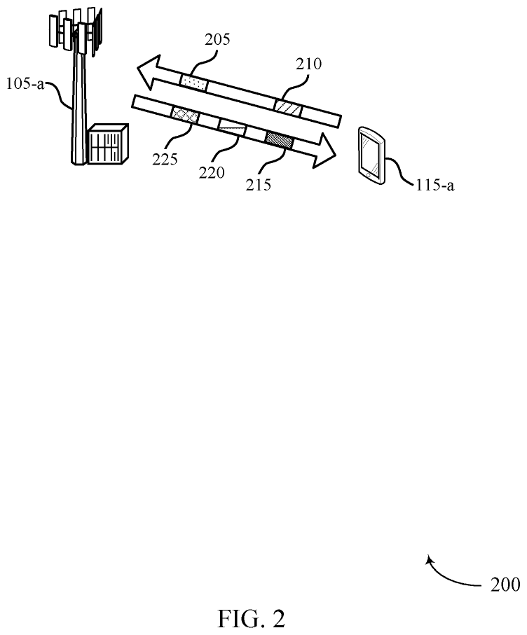

FIG. 2 shows an example of a wireless communications system 200 that supports code block bundle-based interleaving for frequency diversity in accordance with one or more aspects of the present disclosure. In some examples, the wireless communications system 200 may implement or be implemented by aspects of the wireless communications system 100. For example, the wireless communications system 200 may include one or more network entities 105 (e.g., a network entity 105-a) and one or more UEs 115 (e.g., a UE 115-a), which may be examples of the corresponding devices as described with reference to FIG. 1. In some examples, the network entity 105-a may output an indication of a first interleaving value 215 such that the UE 115-a may decode a downlink message 225 based on a first frequency domain interleaving operation (e.g., code block bundle-based interleaving) and a second frequency domain interleaving operation (e.g., PRG-level interleaving). In some examples, frequency domain interleaving within an OFDM symbol may boost a frequency diversity of each code block of a group of code blocks to mitigate subband-specific channel variations (e.g., frequency selective fading, interference from other users, harmonic spurs, radio frequency (RF)/frequency allocation (FA) related frequency glitches, or the like).

Some wireless communications systems use a simple block interleaver (row in/column out) with different RB bundle sizes (e.g., 2 or 4 RB bundles with an interleaving depth of 2). However, while lower bundle size may support increased interleaving gain, channel estimation on a basis of PRG-level granularity may restrict a granularity of a threshold (e.g., lowest) bundle size that a wireless device may use in such interleavers when optimization, such as subband rate matching, is used for UE memory saving. As an illustrative example, at a peak modulation and coding scheme of 256 quadrature amplitude modulation (QAM) for a rank 4, each code block may include 24 RBs, which may be equivalent to 6 PRGs (e.g., assuming a PRG structure of PRG4). In this example, frequency domain interleaving may spread out a respective code block into 6 non-contiguous clusters if PRG level interleaving is used. In some cases, this frequency diversity level may not be sufficient to provide any significant interleaving gain.

In some examples, a code block may be spread across a higher quantity of clusters along an allocated bandwidth. In other words, a code block may be divided into interleavable chunks of smaller size. In some cases, a diversity level of RE level interleaving may be limited by the code block size (e.g., in a quantity of tones). Additionally, smaller code blocks may have less frequency diversity to begin with (e.g., smaller code blocks span a shorter range of frequencies).

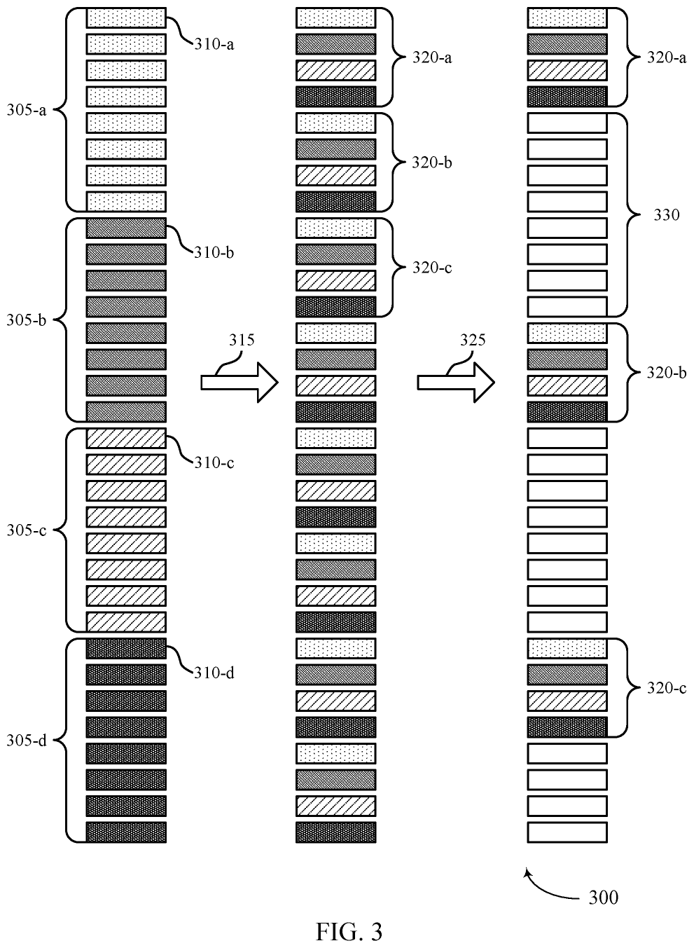

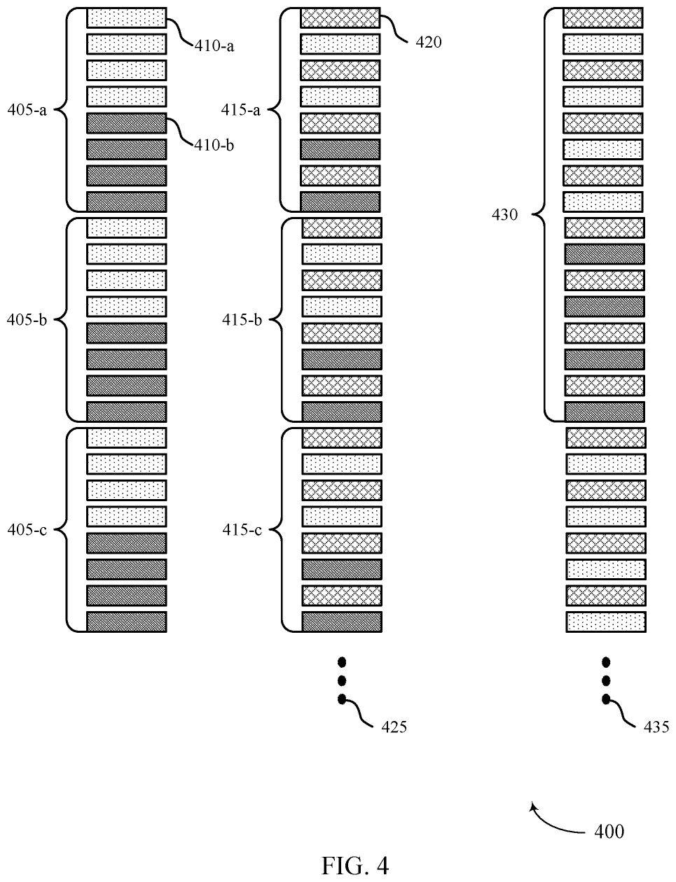

The wireless communications system 200 may support an increase in an effective diversity level of code blocks beyond the quantity of PRGs in a given code block by using an additional interleaving step apart from PRG level interleaving (e.g., VRB-to-PRB mapping or subband rate matching). For example, the network entity 105-a may perform code block bundle-based interleaving (e.g., as discussed further with reference to the first interleaving operation 315 in FIG. 3). The network entity 105-a may group code blocks into bundles of N code blocks and rate match in an interleaved manner within each bundle according to a first interleaving value, K. For example, the network entity 105-a may interleave K REs from each code block of a code block bundle into one or more cycles (e.g., in a round-robin fashion) such that each cycle includes one or more sets of K REs from each code block in the code block bundle. In some cases, one or more REs may not be available on a symbol during the code block bundle-based interleaving. In such cases, the network entity 105-a may rate match data around the one or more unavailable REs, as discussed further with reference to FIG. 4.

In some examples, the UE 115-a may output (e.g., transmit) capability information 205. In some cases, the capability information 205 may indicate that the UE 115-a supports code block bundle-based interleaving. Additionally, or alternatively, the UE 115-a may output a request 210 for code block bundle-based interleaving. In some examples, the network entity 105-a may encode downlink signaling (e.g., may perform the code block bundle-based interleaving) based on the capability information 205, the request 210, or both.

In some examples, the network entity 105-a may output the indication of the first interleaving value 215, K. In some cases, K may denote a quantity of REs from each code block contained in a code block bundle that is interleaved into a respective cycle. For example, each code block in a code block bundle may include 12 REs. In this example, for K=6 REs, the network entity may interleave the first 6 REs of each code block in the bundle into a first cycle and interleave the remaining 6 REs of each code block into a second cycle. The network entity 105-a may output control signaling 220 that enables or disables the first interleaving operation. The network entity 105-a may output the control signaling 220 based on the capability information 205, the request 210, downlink channel state information (CSI), or any combination thereof.

FIG. 3 shows an example of a frequency domain interleaving operation 300 that supports code block bundle-based interleaving for frequency diversity in accordance with one or more aspects of the present disclosure. In some examples, the frequency domain interleaving operation 300 may implement or be implemented by aspects of the wireless communications system 100 or 200. For example, one or more network entities 105 and one or more UEs 115, which may be examples of the corresponding devices as described with reference to FIGS. 1 and 2, may perform the frequency domain interleaving operation 300. FIG. 3 illustrates one example of code block bundle-based interleaving where a first interleaving value, K, is 12 REs. In some examples, a quantity of REs in an RB may be 12. Accordingly, an RB 310 may represent a group of 12 REs. The code block based interleaving may be described with reference to an RB 310 for simplicity, but the interleaving value, K, may be any quantity of REs, any quantity of RBs, any portion of an RE or RB, among other examples (e.g., K may or may not be factor of a quantity of REs in an RB).

In some examples, a network entity 105 may group one or more code blocks 305 into bundles of N code blocks (e.g., based on layer mapping). For example, the network entity 105 may group the one or more code blocks 305 into a bundle of 4 code blocks (e.g., code block 305-a may be code block 0, code block 305-b may be code block 1, code block 305-c may be code block 2, and code block 305-d may be code block 3). Based on grouping the one or more code blocks 305 into the bundle of code blocks, the network entity 105 may rate match in a first interleaved manner (e.g., a frequency first manner) within each bundle as follows:

$${RE}_{0} \to {CB}_{0} , {RE}_{1} \to {CB}_{0} , {RE}_{2} \to {CB}_{0} , … , {RE}_{K - 1} \to {CB}_{0} \\ {RE}_{K} \to {CB}_{1} , {RE}_{K + 1} \to {CB}_{1} , {RE}_{K + 2} \to {CB}_{1} , … , {RE}_{2 K - 1} \to {CB}_{1} \\ … \\ {RE}_{NK - K} \to {CB}_{N} , {RE}_{NK - K = + 1} \to {CB}_{N} , … , {RE}_{NK - 1} \to {CB}_{N - 1}$$

where K may denote a quantity of REs of each code block (CB) contained in a bundle, and the notation REₓ→CB_{y} may indicate that the xth RE carries a symbol from the yth code block. In some cases, values of y may range from 0 to N, and values of x may range from 0 to NK−1.

In some examples, a group of REs rate matched to NK symbols may be denoted as a cycle of the code block bundle. In some cases, there are CB size in REs/K cycles corresponding to a code block bundle. For instance, for K=12 REs and a code block size of 8 RBs (e.g., 96 REs), there may be 8 cycles

$$( e . g . , \frac{96}{12} = 8 )$$

resulting from the first interleaving operation 315.

In some examples, the network entity 105 may choose to pick (e.g., select) K from a pre-defined set of candidate K values (e.g., pre-defined for the network entity 105, a UE 115, or both). In some cases, the network entity 105 may choose K on a per-carrier and BWP basis using RRC messaging (e.g., the network entity 105 may indicate a value of K for each carrier, BWP, etc., via RRC signaling). Additionally, or alternatively, the network entity 105 may choose to use larger K values for lower sub-carrier spacing (SCS) and smaller K values for higher SCS (e.g., channel correlation between successive tones may be dependent on the subcarrier width for a given delay spread).

A first interleaving operation 315 may occur according to the first interleaved manner described herein. For example, a first RB 310-a representing a quantity of 12 REs (K=12 in FIG. 3) from code block 305-a may be interleaved with a first RB 310-b from code block 305-b, a first RB 310-c from code block 305-c, and a first RB 310-d from code block 305-d into a first cycle 320-a. A second RB 310-a from code block 305-a, a second RB 310-b from code block 305-b, a second RB 310-c from code block 305-c, and a second RB 310-d from code block 305-d may be interleaved into a second cycle 320-b. Similarly, a third RB from each code block 305 may be interleaved into a third cycle 320-c. The network entity 105 may interleave the bundle of code blocks into 8 cycles according to the first interleaving operation 315 (e.g., a code block size of 8 RBs corresponds to 96 REs, and =8 cycles for the example of K=12).

$$\frac{96}{12} = 8$$

The network entity 105 may interleave the cycles across other frequency resources in a second interleaving operation 325. For example, the network entity 105 may interleave one or more cycles 320 across frequency resources (e.g., across a range of REs) with one or more PRGs 330 from other code block bundles. In some cases, the one or more PRGs 330 may include one or more other cycles interleaved from another set of CBs according to the first interleaved manner (e.g., with a same or different value of K). In some examples, the network entity 105 may interleave the one or more cycles 320 (e.g., the first cycle 320-a, the second cycle 320-b, and the third cycle 320-c) across one or more PRGs 330 that may or may not be interleaved according to the first interleaving operation 315 (e.g., to increase frequency diversity). Additionally, or alternatively, the network entity 105 may interleave the one or more cycles 320 across one or more RBs or REs (e.g., an RB may include one or more REs). For example, the network entity 105 may interleave the one or more cycles across 2 or 4 RBs. The spacing between the one or more cycles 320 may be the same or different. In some cases, the network entity 105 may transmit a downlink message based on the second interleaving operation 325. For example, having performed both the first interleaving operation 315 and the second interleaving operation 325, the network entity 105 may transmit the downlink message via the frequency resources resulting from the second interleaving operation 325.

In some examples, each code block before the first interleaving operation 315 may include n PRGs. In such examples, there may be N*n PRGs for N code blocks in the bundle (e.g., for a PRG size of 4 RBs, a code block size of 2 PRGs, and 4 code blocks in a bundle, there may be 8 PRGs the illustrative example of FIG. 3). Based on the first interleaving operation 315 and the second interleaving operation 325, each code block may be spread over n noncontiguous clusters (e.g., achieving a diversity level of n).

A group of contiguous NK REs, where each K REs is allotted to a different code block in a code block bundle, may be a hybrid code block. In some examples, each hybrid code block may include n′ PRGs, where

$${n}^{′} = \frac{N}{PRG Size} .$$

In some cases, there may be n*PRG Size hybrid code blocks, and each hybrid code block may have a diversity level of n′ for each RE. Each code block have an overall diversity level of n′*n*PRG size=N*n (e.g., which may be N times larger than interleaving methods that do not implement the first interleaving operation 315). The description herein may assume each code block consists of an integer quantity of PRGs (e.g., n is an integer), and may be regarded as a special case. Generalization to non-integer n, interleaving RBs or REs (e.g., rather than PRGs), or any combination thereof, may be straightforward (e.g., the equations described herein may be applied to non-integer n, RB or RE size).

In some examples, a UE 115 may receive and decode the downlink message according to a first deinterleaving operation and a second deinterleaving operation. For example, the first deinterleaving operation may include PRG level de-interleaving, where the UE 115 may perform the second interleaving operation 325 in reverse (e.g., the UE 115 may deinterleave the first cycle 320-a, the second cycle 320-b, and the third cycle 320-c from the one or more PRGs 330). Based on the first deinterleaving operation, the UE 115 may perform a second deinterleaving operation. In some examples, the second deinterleaving operation may include code block bundle based de-interleaving, where the UE 115 may perform the first interleaving operation 315 in reverse (e.g., the UE 115 may deinterleave a first RB 310-a, a second RB 310-b, a third RB 310-c, and a fourth RB 310-d into the first code block 305-a, the second code block 305-b, the third code block 305-c, and the fourth code block 305-d, respectively). In some examples, based on the second deinterleaving operation, the UE 115 may perform layer de-mapping and decode the downlink message.

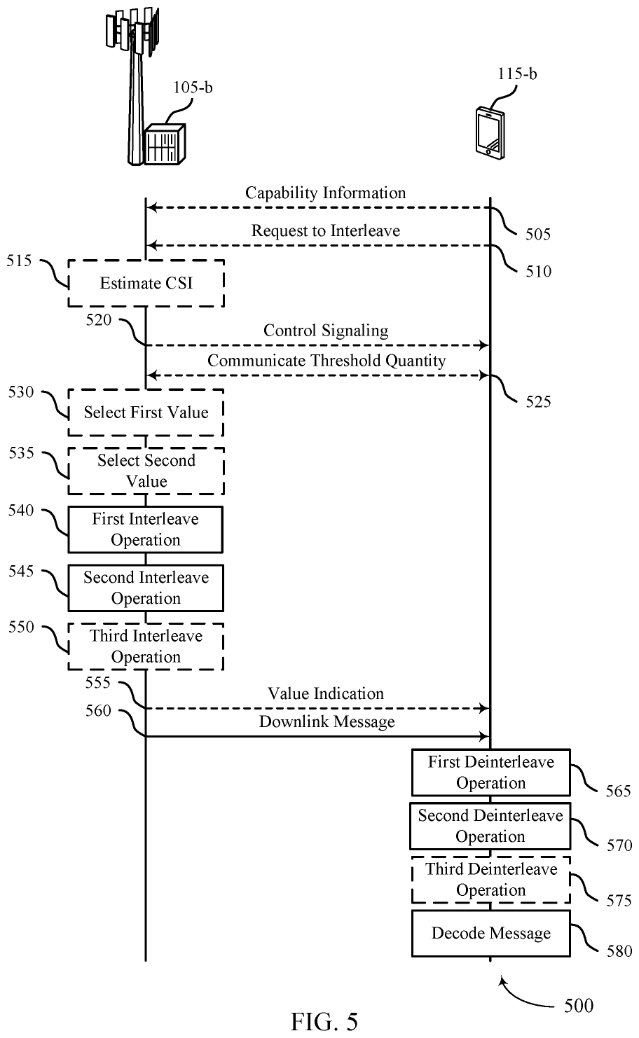

In some cases, larger code block bundle size N may enable a larger diversity level and the UE 115 may decode the downlink message based on receiving all code blocks in a bundle (e.g., decoding of code blocks may be delayed and have an impact of overall processing timeline for larger code block bundle sizes). In some aspects, the UE 115 may store N times the quantity of code blocks in a buffer, according to a supported buffer size of the UE 115. In some examples, the UE 115 may report a capability to support code block interleaving (e.g., the first interleaving operation 315), and the network entity 105 may enable or disable the code block bundling. Additionally, or alternatively, the network entity 105 may determine whether to interleave code block bundles or not depending on a MCS and rank information based on downlink CSI. Capability signaling and enabling or disabling code block bundle-based interleaving is discussed further with reference to FIG. 5.

FIG. 4 shows an example of a frequency domain interleaving operation 400 that supports code block bundle-based interleaving for frequency diversity in accordance with one or more aspects of the present disclosure. In some examples, the frequency domain interleaving operation 400 may implement or be implemented by aspects of the wireless communications system 100 or 200. For example, one or more network entities 105 and one or more UEs 115, which may be examples of the corresponding devices as described with reference to FIGS. 1 and 2, may perform frequency domain interleaving operation 400. FIG. 4 illustrates an example of code block bundle-based interleaving with punctured REs.

As a non-limiting example, a network entity may apply each option for symbols with demodulation reference signals (DMRS) frequency-division multiplexed with a physical downlink shared channel (PDSCH), a physical uplink shared channel (PUSCH), or both, with a 50% overhead (OH), and a code block bundle size of 2 code blocks. In some examples, a data only symbol may have a cycle length of 8 REs 410 and a K value of 4. For example, a first cycle 405-a, a second cycle 405-b, and a third cycle 405-c may respectively include 8 REs in a data only symbol. One or more first REs 410-a and one or more second REs 410-b may be interleaved based on the K value. FIG. 4 illustrates a regularly spaced comb structure of RS tones puncturing data resources, but this is one example and the techniques described herein may be applied for any frequency domain pattern of punctured or RS resources.

In some examples, one or more REs may not be available for data on a symbol. In such examples, a network entity 105 may rate match data around the one or more unavailable REs 420. In some examples, the network entity 105 may pick one or more K REs 410 available for data allocation in the frequency domain at a time and identify an interleaving value K′ (e.g., where K′<K) out of the one or more K REs 410 available for data allocation and allot (e.g., interleave) them to a code block. In some cases, the network entity 105 may repeat this interleaving operation for all code blocks and code block bundles. In such examples, each cycle may include K′ symbols from each member code block instead of K symbols (e.g., compared to the one or more cycles 320 in FIG. 3), and correlation across the channel seen by interleaving REs of a member code block may be the same as that in the data only symbol. For example, the network entity 105 may allot the one or more cycles 415 using K′=2, where two first REs 410-a and two second REs 410-b are allocated between one or more unavailable REs 420 in a first cycle 415-a. The network entity 105 may repeat this allocation process for a second cycle 415-b, a third cycle 415-c, etc. for the remaining code blocks and code block bundles 425. In some examples, a length of the one or more cycles 415 may be 8 REs.

Additionally, or alternatively, the network entity 105 may pick one or more K symbols at a time from a code block, identify an interleaving value K REs available for data out of K″ (e.g., where K″>K) REs, allot (e.g., interleave) the one or more K symbols from each member code block, and repeat for all code blocks and code block bundles. In some cases, each cycle may have K symbols from each member code block, but the effective span of each cycle may be K′ REs, including the punctured resources. For example, one or more cycles 430 may be allotted using K″=8, where 4 first REs 410-a and four second REs 410-b are allotted between 4 unavailable REs 420, and a length of the one or more cycles 430 may be 16 REs. The network entity 105 may repeat this interleaving operation for all the remaining code blocks and code block bundles 435. In some cases, this process may support less complex processing across the symbols.

In some examples, the network entity 105 may perform a second interleaving operation (e.g., corresponding to the second interleaving operation 325 described with reference to FIG. 3) based on interleaving according to the interleaving value K′ or the interleaving value K REs available for data out of K′. For example, each of the interleaving values, K′ or K, may be a second interleaving value less than or equal to a first interleaving value corresponding to a first interleaving operation. In some cases, the network entity 105 may interleave according to the second interleaving value in place of interleaving according to the first interleaving value (e.g., corresponding to the first interleaving operation 315) based on the one or more unavailable REs 420.

FIG. 5 shows an example of a process flow 500 that supports code block bundle-based interleaving for frequency diversity in accordance with one or more aspects of the present disclosure. The process flow 500 may be performed by aspects of the wireless communications system 100 or the wireless communications system 200, as described herein with reference to FIGS. 1 and 2. For example, a network entity 105-b and a UE 115-b, which may be examples of a network entity 105 and a UE 115 as described herein, may perform aspects of the process flow 500. In the following description of the process flow 500, operations performed by the network entity 105-b and the UE 115-b may be performed in a different order than is shown. Some operations may be omitted from the process flow 500, and other operations may be added to the process flow 500. Further, although some operations or signaling may be shown to occur at different times for discussion purposes, these operations may occur at the same time.

At 505, the UE 115-b may output capability information indicating that the UE 115-b supports a first interleaving operation (e.g., the first interleaving operation 315 described in FIG. 3). In some cases, the first interleaving operation at the network entity 105-b may correspond to a second deinterleaving operation at the UE 115-b and the second interleaving operation at the network entity 105-b may correspond to a first deinterleaving operation at the UE 115-b. In some examples, the capability information may include an indication of a first threshold quantity of code blocks supported by the UE for deinterleaving a downlink message according to a deinterleaving operation corresponding to the first interleaving operation. For example, the UE 115-b may report a quantity (e.g., a maximum quantity) of supported code block bundle sizes N (in quantity of code blocks) based on buffer constraints and delay tolerance in data processing of the UE 115-b. In some cases, the network entity 105-b may enable the downlink message based on the quantity of supported code blocks satisfying a threshold.

In some examples, at 510, the UE 115-b may output a request for the network entity 105-b to perform the first interleaving operation. In some cases, the UE 115-b may output the request based on a threshold delay spread associated with an estimated delay spread. For example, the UE 115-b may request the network entity 105-b to selectively enable code block interleaving above the threshold delay spread estimated at receiving side. In some aspects, such as at lower delay spreads, code block bundle-based interleaving may not gain much from channel selectivity, whereas at higher delay aspects, code block bundle-based interleaving may benefit from inherent channel selectivity. In such examples, the network entity 105-b decides to selectively enable the code block bundle-based interleaving or not.

At 515, the network entity 105-b may estimate downlink CSI for the downlink message. In some examples, the network entity 105-b may determine whether to interleave code blocks or not depending on a MCS and rank information based on the downlink CSI. For example, if n is already high (at lower QAM/rank), the network entity 105-b may choose not to enable code block interleaving.

At 520, the network entity 105-b may output control signaling enabling the first interleaving operation. In some cases, the enabling or disabling of code block bundling (e.g., the first interleaving operation) may be RRC configured or controlled by MAC-CE. Additionally, or alternatively, the enabling or disabling of code block bundling may be on a slot-by-slot basis as indicated in downlink control information (DCI).

In some examples, the network entity 105-b may output the control signaling based on obtaining the capability information from the UE 115-b. For example, the network entity 105-b may choose to enable code block interleaving if a quantity of code blocks exceeds a threshold (e.g., few code blocks may not provide much interleaving gain). In some cases, the network entity 105-b may choose the overall code block bundle size N′≤min(N, #code blocks) code blocks for each transport block. In such cases, the network entity 105-b may compute the size of each individual code block bundle as follows: determine the quantity of code block bundles as M, where M=ceiling(C/N′), and where C is the total quantity of code blocks, the first mod(C,M) code block bundles contain N′ code blocks each, and the remaining (M-mod(C,M)) code block bundles contain N′−1 code blocks each. Based on the computation of each individual code block bundle, a size delta between code block bundles may not exceed 1 code block.

At 525, the UE 115-b and the network entity 105-b may communicate, via RRC signaling or DCI signaling, an indication of a threshold quantity of code blocks for the first interleaving operation. In some aspects, the threshold quantity of code blocks may be a threshold quantity of code blocks above which code block interleaving may be enabled. Additionally, or alternatively, the network entity 105-b may selectively enable code block bundle-based interleaving based on a bandwidth allocation. In some examples, at higher bandwidths, a code block may get spread over a wide frequency span and experience higher diversity compared to some examples at lower bandwidths.

At 530, the network entity 105-b may select a first interleaving value (e.g., K) from multiple candidate interleaving values based on a carrier frequency associated with the downlink message, a BWP associated with the downlink message, an SCS associated with the downlink message, or any combination thereof. Additionally, or alternatively, at 535, the network entity 105-b may select a second interleaving value (e.g., K′ or K) based on one or more unavailable REs of the first quantity of REs, as described in greater detail with reference to FIG. 4. In some examples, the second interleaving value may be lower than the first interleaving value (e.g., K′) or equal to the first interleaving value. Techniques described herein may then be performed using the selected interleaving value (e.g., the first interleaving value K as described with reference to FIG. 3, or the second interleaving value K′ or K as described with reference to FIG. 4).

At 540, the network entity 105-b may perform the first interleaving operation to interleave a first quantity of REs of each respective code block of multiple code blocks into a respective cycle of multiple cycles, as described in greater detail with reference to the first interleaving operation 315 in FIG. 3. In some examples, the network entity 105-b may interleave the first quantity of REs according to the first interleaving value. Additionally, or alternatively, the network entity 105-b may perform the first interleaving operation according to a bandwidth allocation associated with the downlink message. In some cases, the network entity 105-b may perform the first interleaving operation based on outputting the control signaling enabling the first interleaving operation, the quantity of code blocks satisfying the threshold quantity of code blocks, the request from the UE 115-b, or any combination thereof.

At 545, the network entity 105-b may perform a second interleave operation to interleave each cycle of the multiple cycles with a second group of REs (e.g., one or more REs, one or more RBs, one or more PRGs, and the like) corresponding to a second group of code blocks, as described in greater detail with reference to the second interleaving operation 325 in FIG. 3.

Additionally, or alternatively, at 550, the network entity 105-b may perform a third interleaving operation to interleave a third group of REs, the third group of REs corresponding to the second interleaving value. For example, the network entity 105-b may perform the third interleaving value operation according to the second interleaving value as described with reference to FIG. 4. In some cases, the network entity 105-b may perform the third interleaving operation in place of the first interleaving operation (e.g., based on one or more REs unavailable for data on a symbol). In such cases, each cycle of the multiple cycles may be based on the third interleaving operation (e.g., the network entity 105-b may perform the second interleaving operation based on the third interleaving operation).

At 555, the network entity 105-b may output an indication of the first interleaving value. In some examples, the network entity 105-b may output an indication of the second interleaving value. At 560, the network entity 105-b may output the downlink message based on the first interleaving operation and the second interleaving operation. Additionally, or alternatively, the network entity 105-b may output the downlink message based on outputting the indication of the first interleaving value, the outputting the control signaling enabling the first interleaving operation, or both.

At 565, the UE 115-b may perform a first deinterleaving operation to deinterleave the downlink message into a group of cycles. At 570, the UE 115-b may perform a second deinterleaving operation to deinterleave each cycle of the group of cycles into a respective code block of a group of code blocks according to the first interleaving value. In some cases, each cycle of the group of cycles may include at least a first quantity of REs corresponding to the first interleaving value. In some examples, the UE 115-b may perform the first deinterleaving operation, the second deinterleaving operation, or both based on obtaining the first interleaving value.

In some examples, at 575, the UE 115-b may perform a third deinterleaving operation to deinterleave the group of code blocks according to the second interleaving value. In some examples, each cycle of the group of cycles may be based on the third interleaving operation. For example, in an instance where K′ is selected at 535, the UE 115-b may perform steps 565 through 580 utilizing the value of K′ and addressing the unavailable or punctured REs as described in greater detail with reference to FIG. 4. In some cases, the UE 115-b may perform the third deinterleaving operation in place of the second deinterleaving operation (e.g., the UE 115-b may perform the third deinterleaving operation based on one or more unavailable REs).

At 580, the UE 115-b may decode the downlink message based on the first deinterleaving operation and the second deinterleaving operation. Additionally, or alternatively, the UE 115-b may decode the downlink message based on the third deinterleaving operation.

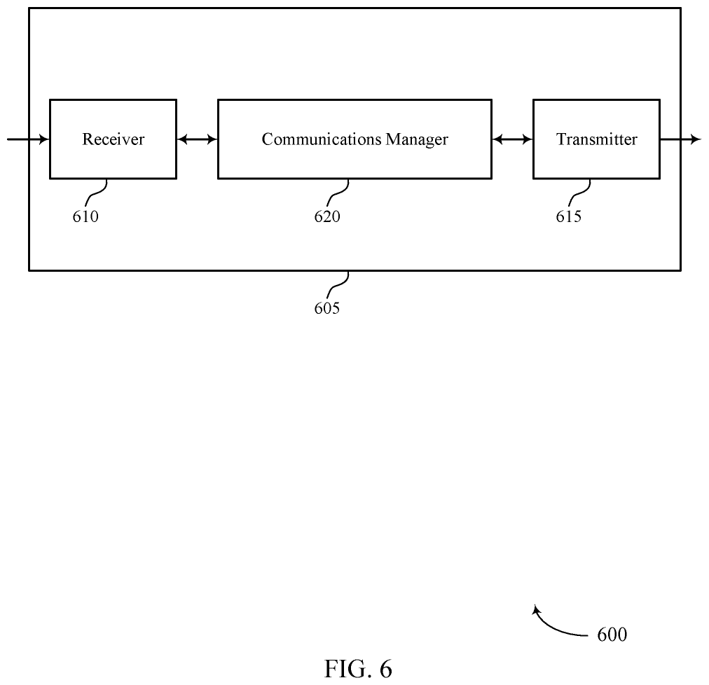

FIG. 6 shows a block diagram 600 of a device 605 that supports code block bundle-based interleaving for frequency diversity in accordance with one or more aspects of the present disclosure. The device 605 may be an example of aspects of a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of code block bundle-based interleaving for frequency diversity as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for performing a first interleaving operation to interleave a first quantity of REs of each respective code block of a set of multiple code blocks into a respective cycle of a set of multiple cycles, the first quantity of REs corresponding to a first interleaving value. The communications manager 620 is capable of, configured to, or operable to support a means for performing a second interleaving operation to interleave each cycle of the set of multiple cycles with a second quantity of REs corresponding to a second set of multiple code blocks. The communications manager 620 is capable of, configured to, or operable to support a means for outputting a downlink message based on the first interleaving operation and the second interleaving operation.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources.

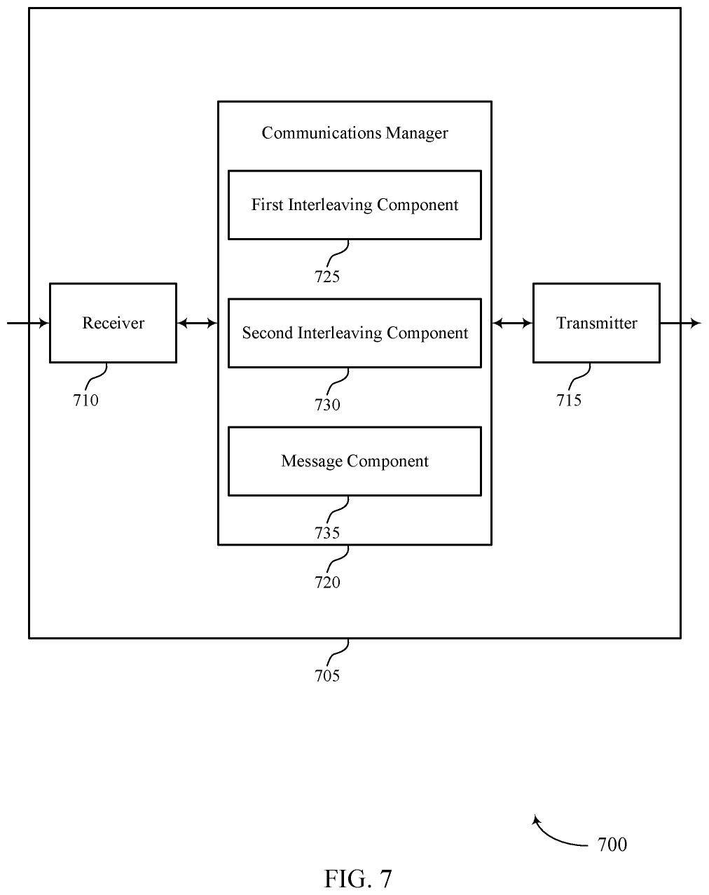

FIG. 7 shows a block diagram 700 of a device 705 that supports code block bundle-based interleaving for frequency diversity in accordance with one or more aspects of the present disclosure. The device 705 may be an example of aspects of a device 605 or a network entity 105 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of code block bundle-based interleaving for frequency diversity as described herein. For example, the communications manager 720 may include a first interleaving component 725, a second interleaving component 730, a message component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The first interleaving component 725 is capable of, configured to, or operable to support a means for performing a first interleaving operation to interleave a first quantity of REs of each respective code block of a set of multiple code blocks into a respective cycle of a set of multiple cycles, the first quantity of REs corresponding to a first interleaving value. The second interleaving component 730 is capable of, configured to, or operable to support a means for performing a second interleaving operation to interleave each cycle of the set of multiple cycles with a second quantity of REs corresponding to a second set of multiple code blocks. The message component 735 is capable of, configured to, or operable to support a means for outputting a downlink message based on the first interleaving operation and the second interleaving operation.

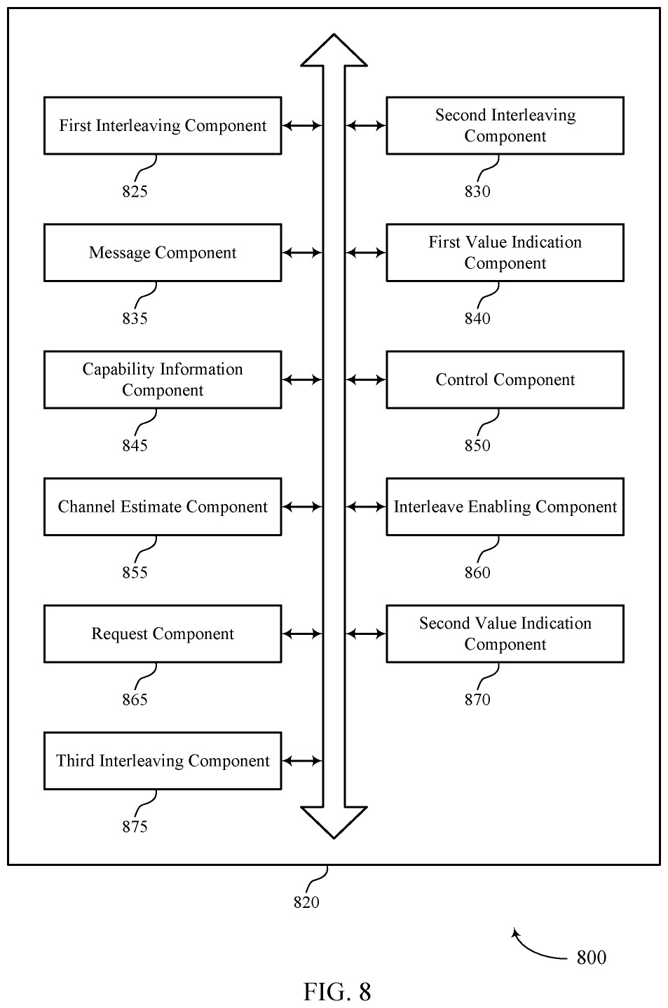

FIG. 8 shows a block diagram 800 of a communications manager 820 that supports code block bundle-based interleaving for frequency diversity in accordance with one or more aspects of the present disclosure. The communications manager 820 may be an example of aspects of a communications manager 620, a communications manager 720, or both, as described herein. The communications manager 820, or various components thereof, may be an example of means for performing various aspects of code block bundle-based interleaving for frequency diversity as described herein. For example, the communications manager 820 may include a first interleaving component 825, a second interleaving component 830, a message component 835, a first value indication component 840, a capability information component 845, a control component 850, a channel estimate component 855, an interleave enabling component 860, a request component 865, a second value indication component 870, a third interleaving component 875, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The first interleaving component 825 is capable of, configured to, or operable to support a means for performing a first interleaving operation to interleave a first quantity of REs of each respective code block of a set of multiple code blocks into a respective cycle of a set of multiple cycles, the first quantity of REs corresponding to a first interleaving value. The second interleaving component 830 is capable of, configured to, or operable to support a means for performing a second interleaving operation to interleave each cycle of the set of multiple cycles with a second quantity of REs corresponding to a second set of multiple code blocks. The message component 835 is capable of, configured to, or operable to support a means for outputting a downlink message based on the first interleaving operation and the second interleaving operation.

In some examples, the first value indication component 840 is capable of, configured to, or operable to support a means for outputting an indication of the first interleaving value, where outputting the downlink message is based on outputting the indication of the first interleaving value. In some examples, to support outputting the indication of the first interleaving value, the first value indication component 840 is capable of, configured to, or operable to support a means for selecting the first interleaving value from a set of multiple candidate interleaving values based on one or more of: a carrier frequency associated with the downlink message, a bandwidth part associated with the downlink message, a subcarrier spacing associated with the downlink message, or any combination thereof.

In some examples, the capability information component 845 is capable of, configured to, or operable to support a means for obtaining capability information indicating that a UE supports the first interleaving operation. In some examples, the control component 850 is capable of, configured to, or operable to support a means for outputting control signaling enabling the first interleaving operation based on obtaining the capability information, where performing the first interleaving operation and outputting the downlink message is based on outputting the control signaling enabling the first interleaving operation.

In some examples, the capability information includes an indication of a first threshold quantity of code blocks supported by the UE for deinterleaving the downlink message according to a deinterleaving operation corresponding to the first interleaving operation. In some examples, enabling the first interleaving operation is based on the first quantity of supported code blocks satisfying a threshold. In some examples, the set of multiple code blocks is based on the capability information. In some examples, a quantity of the set of multiple code blocks satisfies the first threshold quantity of code blocks.

In some examples, the channel estimate component 855 is capable of, configured to, or operable to support a means for estimating downlink channel state information for the downlink message. In some examples, the interleave enabling component 860 is capable of, configured to, or operable to support a means for enabling the first interleaving operation based on a channel rank, a modulation and coding scheme, or both, associated with the estimated downlink channel state information.

In some examples, the request component 865 is capable of, configured to, or operable to support a means for obtaining a request to perform the first interleaving operation based on a threshold delay spread associated with an estimated delay spread, where performing the first interleaving operation is based on the request. In some examples, performing the first interleaving operation is based on a bandwidth allocation associated with the downlink message.

In some examples, the second value indication component 870 is capable of, configured to, or operable to support a means for selecting a second interleaving value based on one or more unavailable REs of the first quantity of REs, the second interleaving value being lower than the first interleaving value. In some examples, the third interleaving component 875 is capable of, configured to, or operable to support a means for performing a third interleaving operation to interleave a third quantity of REs, the third quantity of REs corresponding to the second interleaving value, where each cycle of the set of multiple cycles is based on the third interleaving operation.

In some examples, the second value indication component 870 is capable of, configured to, or operable to support a means for selecting a second interleaving value based on one or more unavailable REs of the first quantity of REs, the second interleaving value equal to the first interleaving value. In some examples, the third interleaving component 875 is capable of, configured to, or operable to support a means for performing a third interleaving operation to interleave a third quantity of REs, the third quantity of REs corresponding to the second interleaving value, where each cycle of the set of multiple cycles is based on the third interleaving operation.

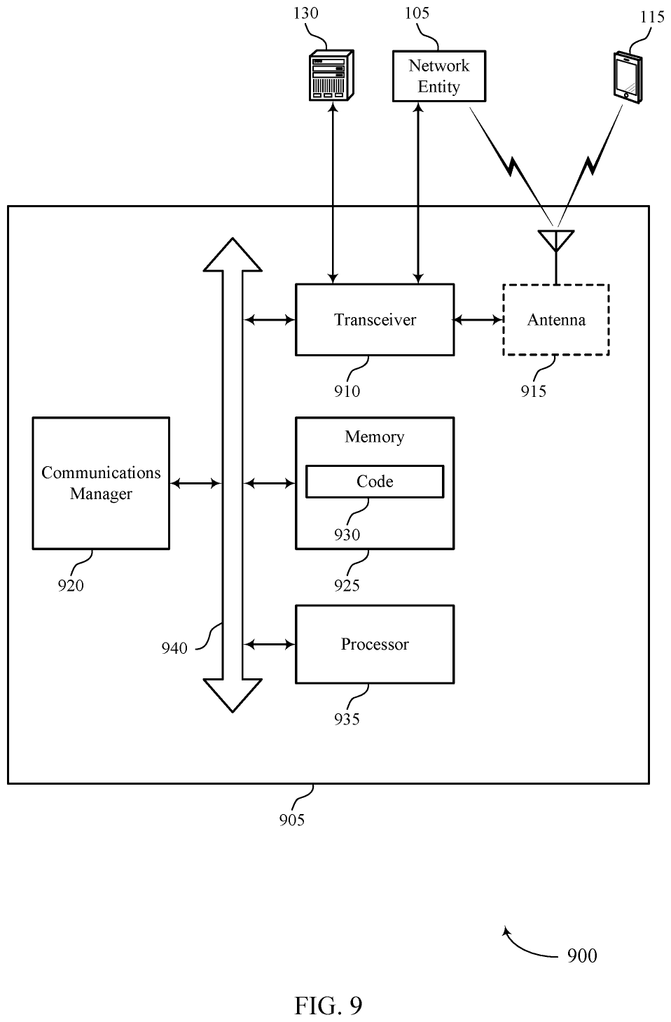

FIG. 9 shows a diagram of a system 900 including a device 905 that supports code block bundle-based interleaving for frequency diversity in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, at least one memory 925, code 930, and at least one processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. In some implementations, the transceiver 910 may include one or more interfaces, such as one or more interfaces coupled with the one or more antennas 915 that are configured to support various receiving or obtaining operations, or one or more interfaces coupled with the one or more antennas 915 that are configured to support various transmitting or outputting operations, or a combination thereof. In some implementations, the transceiver 910 may include or be configured for coupling with one or more processors or one or more memory components that are operable to perform or support operations based on received or obtained information or signals, or to generate information or other signals for transmission or other outputting, or any combination thereof. In some implementations, the transceiver 910, or the transceiver 910 and the one or more antennas 915, or the transceiver 910 and the one or more antennas 915 and one or more processors or one or more memory components (e.g., the at least one processor 935, the at least one memory 925, or both), may be included in a chip or chip assembly that is installed in the device 905. In some examples, the transceiver 910 may be operable to support communications via one or more communications links (e.g., a communication link 125, a backhaul communication link 120, a midhaul communication link 162, a fronthaul communication link 168).

The at least one memory 925 may include RAM, ROM, or any combination thereof. The at least one memory 925 may store computer-readable, computer-executable code 930 including instructions that, when executed by one or more of the at least one processor 935, cause the device 905 to perform various functions described herein. The code 930 may be stored in a non-transitory computer-readable medium such as system memory or another type of memory. In some cases, the code 930 may not be directly executable by a processor of the at least one processor 935 but may cause a computer (e.g., when compiled and executed) to perform functions described herein. In some cases, the at least one memory 925 may contain, among other things, a BIOS which may control basic hardware or software operation such as the interaction with peripheral components or devices. In some examples, the at least one processor 935 may include multiple processors and the at least one memory 925 may include multiple memories. One or more of the multiple processors may be coupled with one or more of the multiple memories which may, individually or collectively, be configured to perform various functions herein (for example, as part of a processing system).

The at least one processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 935 may be configured to operate a memory array using a memory controller. In some other cases, a memory controller may be integrated into one or more of the at least one processor 935. The at least one processor 935 may be configured to execute computer-readable instructions stored in a memory (e.g., one or more of the at least one memory 925) to cause the device 905 to perform various functions (e.g., functions or tasks supporting code block bundle-based interleaving for frequency diversity). For example, the device 905 or a component of the device 905 may include at least one processor 935 and at least one memory 925 coupled with one or more of the at least one processor 935, the at least one processor 935 and the at least one memory 925 configured to perform various functions described herein. The at least one processor 935 may be an example of a cloud-computing platform (e.g., one or more physical nodes and supporting software such as operating systems, virtual machines, or container instances) that may host the functions (e.g., by executing code 930) to perform the functions of the device 905. The at least one processor 935 may be any one or more suitable processors capable of executing scripts or instructions of one or more software programs stored in the device 905 (such as within one or more of the at least one memory 925). In some examples, the at least one processor 935 may include multiple processors and the at least one memory 925 may include multiple memories. One or more of the multiple processors may be coupled with one or more of the multiple memories, which may, individually or collectively, be configured to perform various functions herein. In some examples, the at least one processor 935 may be a component of a processing system, which may refer to a system (such as a series) of machines, circuitry (including, for example, one or both of processor circuitry (which may include the at least one processor 935) and memory circuitry (which may include the at least one memory 925)), or components, that receives or obtains inputs and processes the inputs to produce, generate, or obtain a set of outputs. The processing system may be configured to perform one or more of the functions described herein. For example, the at least one processor 935 or a processing system including the at least one processor 935 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 925 or otherwise, to perform one or more of the functions described herein.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the at least one memory 925, the code 930, and the at least one processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications in accordance with examples as disclosed herein. For example, the communications manager 920 is capable of, configured to, or operable to support a means for performing a first interleaving operation to interleave a first quantity of REs of each respective code block of a set of multiple code blocks into a respective cycle of a set of multiple cycles, the first quantity of REs corresponding to a first interleaving value. The communications manager 920 is capable of, configured to, or operable to support a means for performing a second interleaving operation to interleave each cycle of the set of multiple cycles with a second quantity of REs corresponding to a second set of multiple code blocks. The communications manager 920 is capable of, configured to, or operable to support a means for outputting a downlink message based on the first interleaving operation and the second interleaving operation.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the transceiver 910, one or more of the at least one processor 935, one or more of the at least one memory 925, the code 930, or any combination thereof (for example, by a processing system including at least a portion of the at least one processor 935, the at least one memory 925, the code 930, or any combination thereof). For example, the code 930 may include instructions executable by one or more of the at least one processor 935 to cause the device 905 to perform various aspects of code block bundle-based interleaving for frequency diversity as described herein, or the at least one processor 935 and the at least one memory 925 may be otherwise configured to, individually or collectively, perform or support such operations.

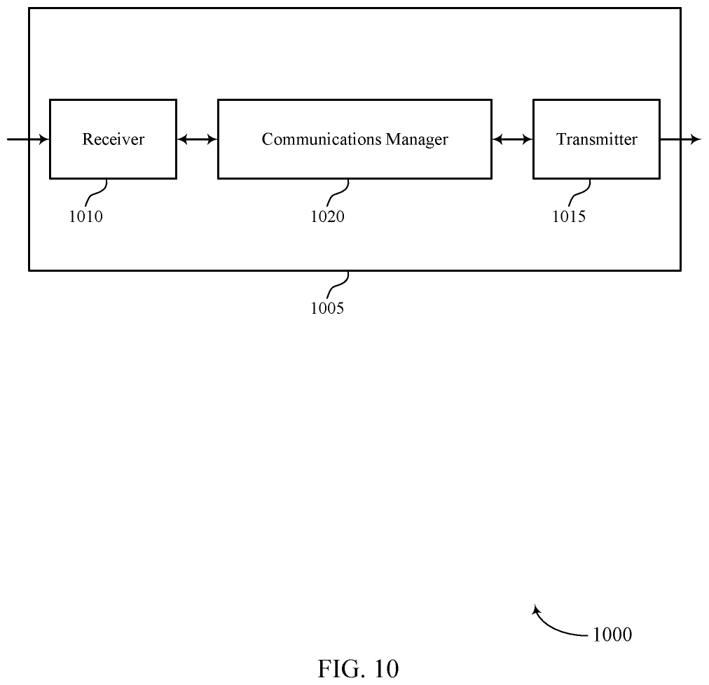

FIG. 10 shows a block diagram 1000 of a device 1005 that supports code block bundle-based interleaving for frequency diversity in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to code block bundle-based interleaving for frequency diversity). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to code block bundle-based interleaving for frequency diversity). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of code block bundle-based interleaving for frequency diversity as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for obtaining a downlink message. The communications manager 1020 is capable of, configured to, or operable to support a means for performing a first deinterleaving operation to deinterleave the downlink message into a set of multiple cycles. The communications manager 1020 is capable of, configured to, or operable to support a means for performing a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value. The communications manager 1020 is capable of, configured to, or operable to support a means for decoding the downlink message based on the first deinterleaving operation and the second deinterleaving operation.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, more efficient utilization of communication resources.

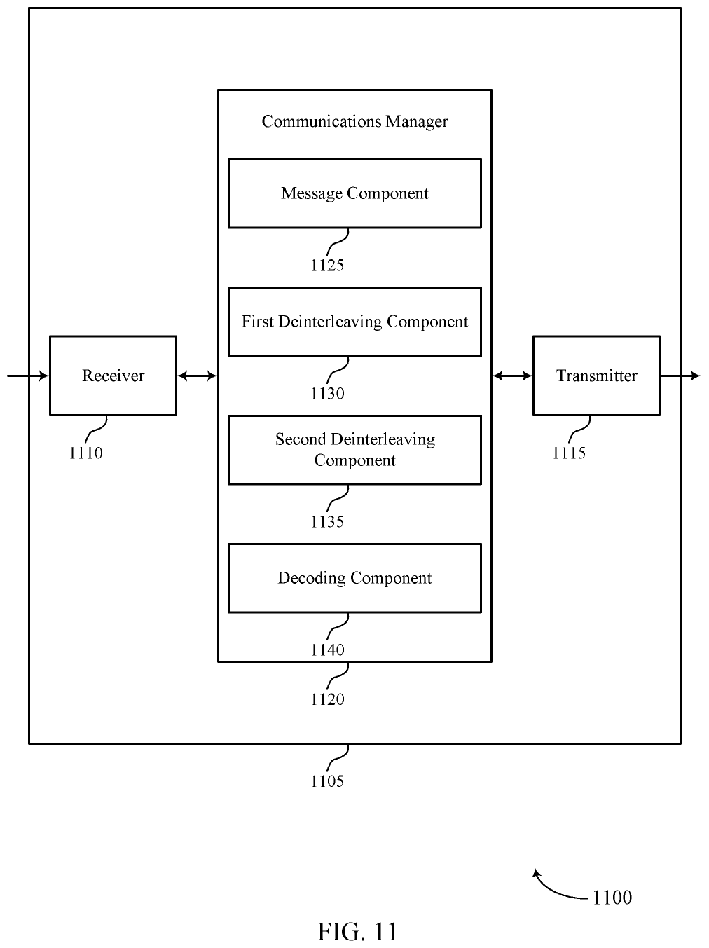

FIG. 11 shows a block diagram 1100 of a device 1105 that supports code block bundle-based interleaving for frequency diversity in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to code block bundle-based interleaving for frequency diversity). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to code block bundle-based interleaving for frequency diversity). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of code block bundle-based interleaving for frequency diversity as described herein. For example, the communications manager 1120 may include a message component 1125, a first deinterleaving component 1130, a second deinterleaving component 1135, a decoding component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The message component 1125 is capable of, configured to, or operable to support a means for obtaining a downlink message. The first deinterleaving component 1130 is capable of, configured to, or operable to support a means for performing a first deinterleaving operation to deinterleave the downlink message into a set of multiple cycles. The second deinterleaving component 1135 is capable of, configured to, or operable to support a means for performing a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value. The decoding component 1140 is capable of, configured to, or operable to support a means for decoding the downlink message based on the first deinterleaving operation and the second deinterleaving operation.

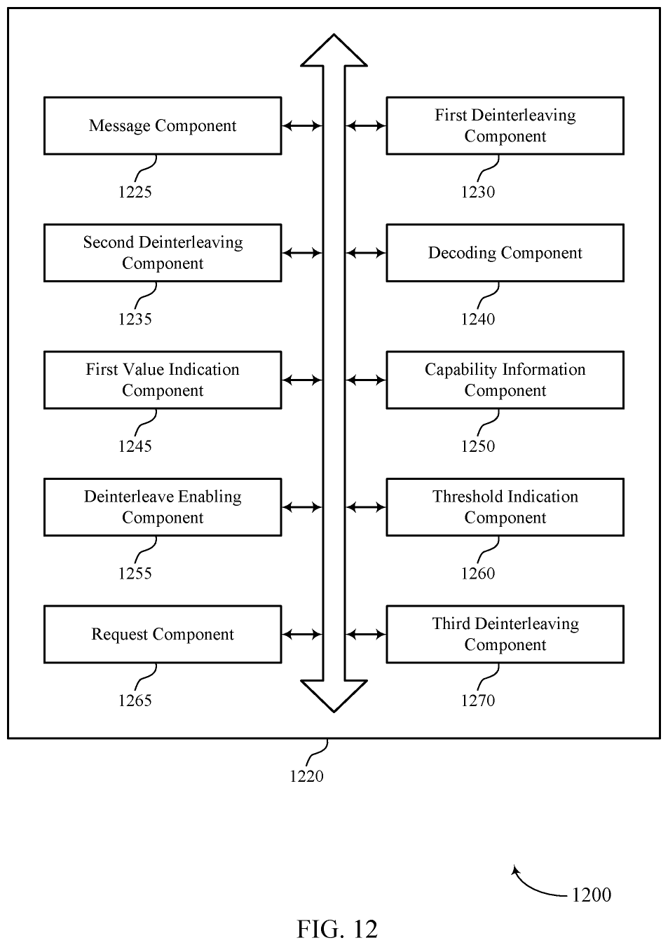

FIG. 12 shows a block diagram 1200 of a communications manager 1220 that supports code block bundle-based interleaving for frequency diversity in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of code block bundle-based interleaving for frequency diversity as described herein. For example, the communications manager 1220 may include a message component 1225, a first deinterleaving component 1230, a second deinterleaving component 1235, a decoding component 1240, a first value indication component 1245, a capability information component 1250, a deinterleave enabling component 1255, a threshold indication component 1260, a request component 1265, a third deinterleaving component 1270, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The message component 1225 is capable of, configured to, or operable to support a means for obtaining a downlink message. The first deinterleaving component 1230 is capable of, configured to, or operable to support a means for performing a first deinterleaving operation to deinterleave the downlink message into a set of multiple cycles. The second deinterleaving component 1235 is capable of, configured to, or operable to support a means for performing a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value. The decoding component 1240 is capable of, configured to, or operable to support a means for decoding the downlink message based on the first deinterleaving operation and the second deinterleaving operation.

In some examples, the first value indication component 1245 is capable of, configured to, or operable to support a means for obtaining an indication of the first interleaving value, where performing the second deinterleaving operation is based on obtaining the indication of the first interleaving value.

In some examples, the capability information component 1250 is capable of, configured to, or operable to support a means for outputting capability information indicating that the UE supports the second deinterleaving operation. In some examples, the deinterleave enabling component 1255 is capable of, configured to, or operable to support a means for obtaining control signaling enabling the second deinterleaving operation based on outputting the capability information, where obtaining the downlink message and performing the second deinterleaving operation is based on obtaining the control signaling enabling the second deinterleaving operation.

In some examples, the capability information includes an indication of a first threshold quantity of code blocks supported by the UE for deinterleaving the downlink message according to the second deinterleaving operation. In some examples, enabling the second deinterleaving operation is based on the first quantity of supported code blocks satisfying a threshold.

In some examples, the deinterleave enabling component 1255 is capable of, configured to, or operable to support a means for obtaining control signaling enabling the second deinterleaving operation based on a channel rank, a modulation and coding scheme, or both, associated with an estimated downlink channel state information.

In some examples, the threshold indication component 1260 is capable of, configured to, or operable to support a means for communicating, via radio resource control signaling or downlink control information signaling, an indication of a threshold quantity of code blocks for the second deinterleaving operation, where performing the second deinterleaving operation is based on the set of multiple code blocks satisfying the threshold quantity of code blocks.

In some examples, the request component 1265 is capable of, configured to, or operable to support a means for outputting a request for the downlink message according to an interleaving operation corresponding to the second deinterleaving operation based on a threshold delay spread associated with an estimated delay spread, where performing the second deinterleaving operation is based on outputting the request.

In some examples, the deinterleave enabling component 1255 is capable of, configured to, or operable to support a means for obtaining control signaling enabling the second deinterleaving operation, where performing the second deinterleaving operation is based on a bandwidth allocation associated with the downlink message.

In some examples, the third deinterleaving component 1270 is capable of, configured to, or operable to support a means for performing a third deinterleaving operation to deinterleave the set of multiple code blocks according to a second interleaving value that is lower than the first interleaving value, where each cycle of the set of multiple cycles is based on the third deinterleaving operation. In some examples, the third deinterleaving component 1270 is capable of, configured to, or operable to support a means for performing a third deinterleaving operation to deinterleave the set of multiple code blocks according to a second interleaving value equal to the first interleaving value, where each cycle of the set of multiple cycles is based on the third deinterleaving operation.

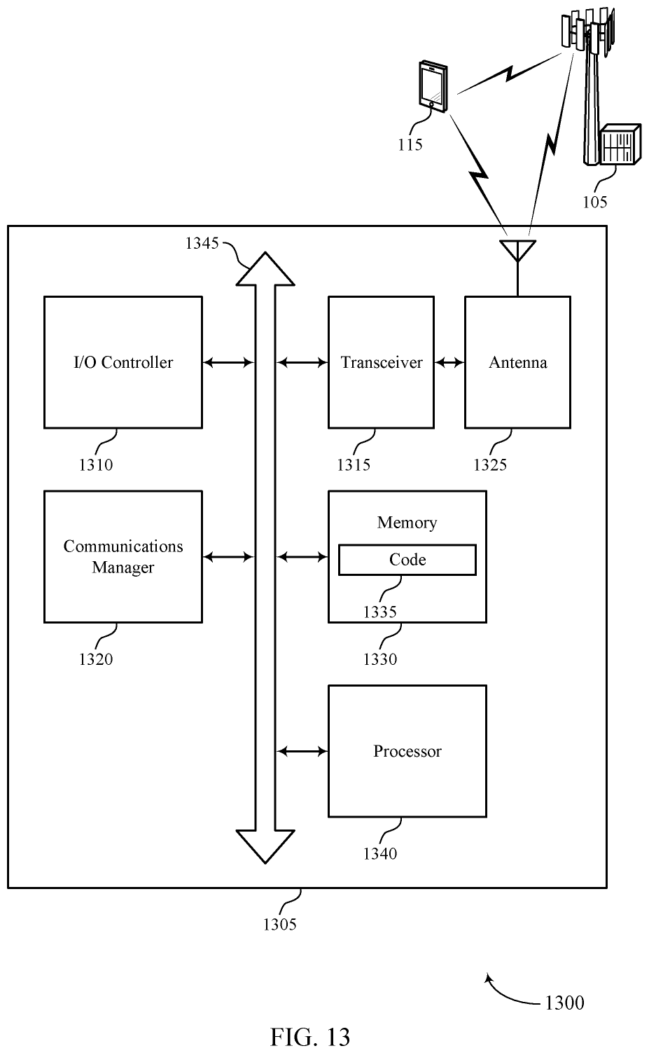

FIG. 13 shows a diagram of a system 1300 including a device 1305 that supports code block bundle-based interleaving for frequency diversity in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable code 1335 including instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may contain, among other things, a basic I/O system (BIOS) which may control basic hardware or software operation such as the interaction with peripheral components or devices.

The at least one processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting code block bundle-based interleaving for frequency diversity). For example, the device 1305 or a component of the device 1305 may include at least one processor 1340 and at least one memory 1330 coupled with or to the at least one processor 1340, the at least one processor 1340 and at least one memory 1330 configured to perform various functions described herein. In some examples, the at least one processor 1340 may include multiple processors and the at least one memory 1330 may include multiple memories. One or more of the multiple processors may be coupled with one or more of the multiple memories, which may, individually or collectively, be configured to perform various functions herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1330 or otherwise, to perform one or more of the functions described herein.

The communications manager 1320 may support wireless communications in accordance with examples as disclosed herein. For example, the communications manager 1320 is capable of, configured to, or operable to support a means for obtaining a downlink message. The communications manager 1320 is capable of, configured to, or operable to support a means for performing a first deinterleaving operation to deinterleave the downlink message into a set of multiple cycles. The communications manager 1320 is capable of, configured to, or operable to support a means for performing a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value. The communications manager 1320 is capable of, configured to, or operable to support a means for decoding the downlink message based on the first deinterleaving operation and the second deinterleaving operation.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of code block bundle-based interleaving for frequency diversity as described herein, or the at least one processor 1340 and the at least one memory 1330 may be otherwise configured to, individually or collectively, perform or support such operations.

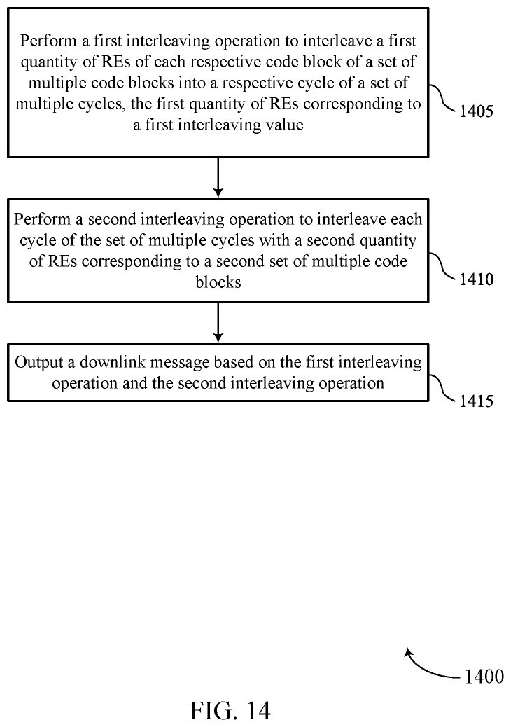

FIG. 14 shows a flowchart illustrating a method 1400 that supports code block bundle-based interleaving for frequency diversity in accordance with one or more aspects of the present disclosure. The operations of the method 1400 may be implemented by a network entity or its components as described herein. For example, the operations of the method 1400 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1405, the method may include performing a first interleaving operation to interleave a first quantity of REs of each respective code block of a set of multiple code blocks into a respective cycle of a set of multiple cycles, the first quantity of REs corresponding to a first interleaving value. The operations of block 1405 may be performed in accordance with examples as disclosed herein. In some examples, aspects of the operations of 1405 may be performed by a first interleaving component 825 as described with reference to FIG. 8.

At 1410, the method may include performing a second interleaving operation to interleave each cycle of the set of multiple cycles with a second quantity of REs corresponding to a second set of multiple code blocks. The operations of block 1410 may be performed in accordance with examples as disclosed herein. In some examples, aspects of the operations of 1410 may be performed by a second interleaving component 830 as described with reference to FIG. 8.

At 1415, the method may include outputting a downlink message based on the first interleaving operation and the second interleaving operation. The operations of block 1415 may be performed in accordance with examples as disclosed herein. In some examples, aspects of the operations of 1415 may be performed by a message component 835 as described with reference to FIG. 8.

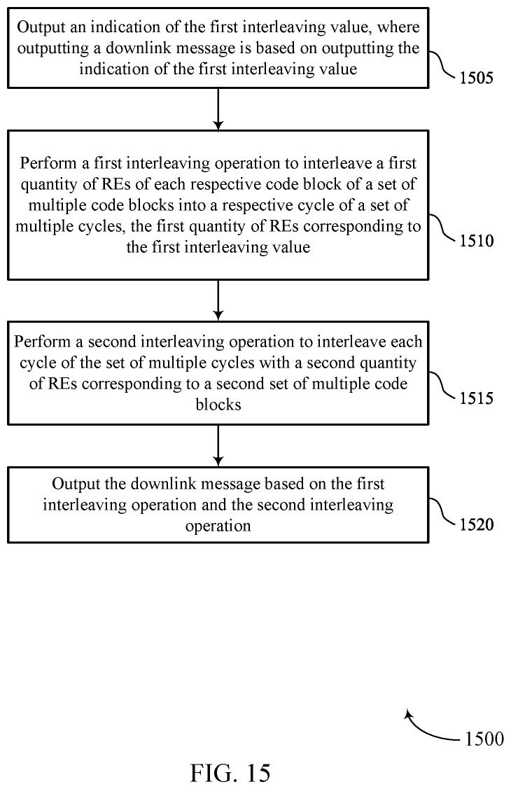

FIG. 15 shows a flowchart illustrating a method 1500 that supports code block bundle-based interleaving for frequency diversity in accordance with one or more aspects of the present disclosure. The operations of the method 1500 may be implemented by a network entity or its components as described herein. For example, the operations of the method 1500 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1505, the method may include outputting an indication of a first interleaving value, where outputting a downlink message is based on outputting the indication of the first interleaving value. The operations of block 1505 may be performed in accordance with examples as disclosed herein. In some examples, aspects of the operations of 1505 may be performed by a first value indication component 840 as described with reference to FIG. 8.

At 1510, the method may include performing a first interleaving operation to interleave a first quantity of REs of each respective code block of a set of multiple code blocks into a respective cycle of a set of multiple cycles, the first quantity of REs corresponding to the first interleaving value. The operations of block 1510 may be performed in accordance with examples as disclosed herein. In some examples, aspects of the operations of 1510 may be performed by a first interleaving component 825 as described with reference to FIG. 8.

At 1515, the method may include performing a second interleaving operation to interleave each cycle of the set of multiple cycles with a second quantity of REs corresponding to a second set of multiple code blocks. The operations of block 1515 may be performed in accordance with examples as disclosed herein. In some examples, aspects of the operations of 1515 may be performed by a second interleaving component 830 as described with reference to FIG. 8.

At 1520, the method may include outputting the downlink message based on the first interleaving operation and the second interleaving operation. The operations of block 1520 may be performed in accordance with examples as disclosed herein. In some examples, aspects of the operations of 1520 may be performed by a message component 835 as described with reference to FIG. 8.

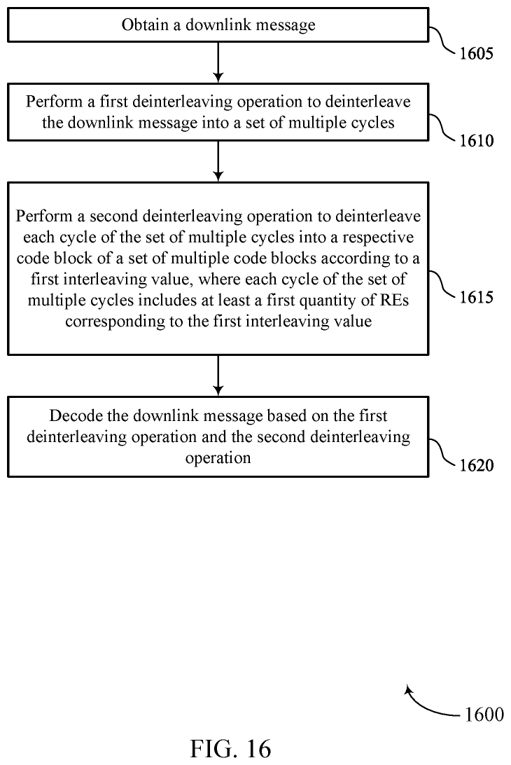

FIG. 16 shows a flowchart illustrating a method 1600 that supports code block bundle-based interleaving for frequency diversity in accordance with one or more aspects of the present disclosure. The operations of the method 1600 may be implemented by a UE or its components as described herein. For example, the operations of the method 1600 may be performed by a UE 115 as described with reference to FIGS. 1 through 5 and 10 through 13. In some examples, a UE may execute a set of instructions to control the functional elements of the UE to perform the described functions. Additionally, or alternatively, the UE may perform aspects of the described functions using special-purpose hardware.

At 1605, the method may include obtaining a downlink message. The operations of block 1605 may be performed in accordance with examples as disclosed herein. In some examples, aspects of the operations of 1605 may be performed by a message component 1225 as described with reference to FIG. 12.

At 1610, the method may include performing a first deinterleaving operation to deinterleave the downlink message into a set of multiple cycles. The operations of block 1610 may be performed in accordance with examples as disclosed herein. In some examples, aspects of the operations of 1610 may be performed by a first deinterleaving component 1230 as described with reference to FIG. 12.

At 1615, the method may include performing a second deinterleaving operation to deinterleave each cycle of the set of multiple cycles into a respective code block of a set of multiple code blocks according to a first interleaving value, where each cycle of the set of multiple cycles includes at least a first quantity of REs corresponding to the first interleaving value. The operations of block 1615 may be performed in accordance with examples as disclosed herein. In some examples, aspects of the operations of 1615 may be performed by a second deinterleaving component 1235 as described with reference to FIG. 12.

At 1620, the method may include decoding the downlink message based on the first deinterleaving operation and the second deinterleaving operation. The operations of block 1620 may be performed in accordance with examples as disclosed herein. In some examples, aspects of the operations of 1620 may be performed by a decoding component 1240 as described with reference to FIG. 12.

The following provides an overview of aspects of the present disclosure:

Aspect 1: A method for wireless communications at a network entity, comprising: performing a first interleaving operation to interleave a first quantity of REs of each respective code block of a plurality of code blocks into a respective cycle of a plurality of cycles, the first quantity of REs corresponding to a first interleaving value; performing a second interleaving operation to interleave each cycle of the plurality of cycles with a second quantity of REs corresponding to a second plurality of code blocks; and outputting a downlink message based at least in part on the first interleaving operation and the second interleaving operation.

Aspect 2: The method of aspect 1, further comprising: outputting an indication of the first interleaving value, wherein outputting the downlink message is based at least in part on outputting the indication of the first interleaving value.

Aspect 3: The method of aspect 2, wherein outputting the indication of the first interleaving value further comprises: selecting the first interleaving value from a plurality of candidate interleaving values based at least in part on one or more of: a carrier frequency associated with the downlink message, a BWP associated with the downlink message, an SCS associated with the downlink message, or any combination thereof.

Aspect 4: The method of any of aspects 1 through 3, further comprising: obtaining capability information indicating that a UE supports the first interleaving operation; and outputting control signaling enabling the first interleaving operation based at least in part on obtaining the capability information, wherein performing the first interleaving operation and outputting the downlink message is based at least in part on outputting the control signaling enabling the first interleaving operation.

Aspect 5: The method of aspect 4, wherein the capability information comprises an indication of a first threshold quantity of code blocks supported by the UE for deinterleaving the downlink message according to a deinterleaving operation corresponding to the first interleaving operation, and enabling the first interleaving operation is based at least in part on the first quantity of supported code blocks satisfying a threshold.

Aspect 6: The method of aspect 5, wherein the plurality of code blocks is based at least in part on the capability information, and a quantity of the plurality of code blocks satisfies the first threshold quantity of code blocks.

Aspect 7: The method of any of aspects 1 through 6, further comprising: estimating downlink CSI for the downlink message; and enabling the first interleaving operation based at least in part on a channel rank, a modulation and coding scheme, or both, associated with the estimated downlink CSI.

Aspect 8: The method of any of aspects 1 through 7, further comprising: obtaining a request to perform the first interleaving operation based at least in part on a threshold delay spread associated with an estimated delay spread, wherein performing the first interleaving operation is based at least in part on the request.

Aspect 9: The method of any of aspects 1 through 8, wherein performing the first interleaving operation is based at least in part on a bandwidth allocation associated with the downlink message.

Aspect 10: The method of any of aspects 1 through 9, further comprising: selecting a second interleaving value based at least in part on one or more unavailable REs of the first quantity of REs, the second interleaving value being lower than the first interleaving value; and performing a third interleaving operation to interleave a third quantity of REs, the third quantity of REs corresponding to the second interleaving value, wherein each cycle of the plurality of cycles is based at least in part on the third interleaving operation.

Aspect 11: The method of any of aspects 1 through 9, further comprising: selecting a second interleaving value based at least in part on one or more unavailable REs of the first quantity of REs, the second interleaving value equal to the first interleaving value; and performing a third interleaving operation to interleave a third quantity of REs, the third quantity of REs corresponding to the second interleaving value, wherein each cycle of the plurality of cycles is based at least in part on the third interleaving operation.

Aspect 12: A method for wireless communications at a UE, comprising: obtaining a downlink message; performing a first deinterleaving operation to deinterleave the downlink message into a plurality of cycles; performing a second deinterleaving operation to deinterleave each cycle of the plurality of cycles into a respective code block of a plurality of code blocks according to a first interleaving value, wherein each cycle of the plurality of cycles comprises at least a first quantity of REs corresponding to the first interleaving value; and decoding the downlink message based at least in part on the first deinterleaving operation and the second deinterleaving operation.

Aspect 13: The method of aspect 12, further comprising: obtaining an indication of the first interleaving value, wherein performing the second deinterleaving operation is based at least in part on obtaining the indication of the first interleaving value.

Aspect 14: The method of any of aspects 12 through 13, further comprising: outputting capability information indicating that the UE supports the second deinterleaving operation; and obtaining control signaling enabling the second deinterleaving operation based at least in part on outputting the capability information, wherein obtaining the downlink message and performing the second deinterleaving operation is based at least in part on obtaining the control signaling enabling the second deinterleaving operation.

Aspect 15: The method of aspect 14, wherein the capability information comprises an indication of a first threshold quantity of code blocks supported by the UE for deinterleaving the downlink message according to the second deinterleaving operation, and enabling the second deinterleaving operation is based at least in part on the first quantity of supported code blocks satisfying a threshold.

Aspect 16: The method of any of aspects 12 through 15, further comprising: obtaining control signaling enabling the second deinterleaving operation based at least in part on a channel rank, a modulation and coding scheme, or both, associated with an estimated downlink CSI.

Aspect 17: The method of any of aspects 12 through 16, further comprising: communicating, via RRC signaling or DCI signaling, an indication of a threshold quantity of code blocks for the second deinterleaving operation, wherein performing the second deinterleaving operation is based at least in part on the plurality of code blocks satisfying the threshold quantity of code blocks.

Aspect 18: The method of any of aspects 12 through 17, further comprising: outputting a request for the downlink message according to an interleaving operation corresponding to the second deinterleaving operation based at least in part on a threshold delay spread associated with an estimated delay spread, wherein performing the second deinterleaving operation is based at least in part on outputting the request.

Aspect 19: The method of any of aspects 12 through 18, further comprising: obtaining control signaling enabling the second deinterleaving operation, wherein performing the second deinterleaving operation is based at least in part on a bandwidth allocation associated with the downlink message.

Aspect 20: The method of any of aspects 12 through 19, further comprising: performing a third deinterleaving operation to deinterleave the plurality of code blocks according to a second interleaving value that is lower than the first interleaving value, wherein each cycle of the plurality of cycles is based at least in part on the third deinterleaving operation.

Aspect 21: The method of any of aspects 12 through 19, further comprising: performing a third deinterleaving operation to deinterleave the plurality of code blocks according to a second interleaving value equal to the first interleaving value, wherein each cycle of the plurality of cycles is based at least in part on the third deinterleaving operation.

Aspect 22: A network entity for wireless communications, comprising one or more memories storing processor-executable code, and one or more processors coupled with the one or more memories and individually or collectively operable to execute the code to cause the network entity to perform a method of any of aspects 1 through 11.

Aspect 23: A network entity for wireless communications, comprising at least one means for performing a method of any of aspects 1 through 11.

Aspect 24: A non-transitory computer-readable medium storing code for wireless communications, the code comprising instructions executable by one or more processors to perform a method of any of aspects 1 through 11.

Aspect 25: A UE for wireless communications, comprising one or more memories storing processor-executable code, and one or more processors coupled with the one or more memories and individually or collectively operable to execute the code to cause the UE to perform a method of any of aspects 12 through 21.

Aspect 26: A UE for wireless communications, comprising at least one means for performing a method of any of aspects 12 through 21.

Aspect 27: A non-transitory computer-readable medium storing code for wireless communications, the code comprising instructions executable by one or more processors to perform a method of any of aspects 12 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
perform a first interleaving operation to interleave a first quantity of resource elements of each respective code block of a plurality of code blocks into a respective cycle of a plurality of cycles, the first quantity of resource elements corresponding to a first interleaving value;
perform a second interleaving operation to interleave each cycle of the plurality of cycles with a second quantity of resource elements corresponding to a second plurality of code blocks; and
output a downlink message based at least in part on the first interleaving operation and the second interleaving operation.

2. The network entity of claim 1, wherein the one or more processors are individually or collectively further operable to execute the code to cause the network entity to:
output an indication of the first interleaving value, wherein outputting the downlink message is based at least in part on outputting the indication of the first interleaving value.

3. The network entity of claim 2, wherein, to output the indication of the first interleaving value, the one or more processors are individually or collectively further operable to execute the code to cause the network entity to:
select the first interleaving value from a plurality of candidate interleaving values based at least in part on one or more of: a carrier frequency associated with the downlink message, a bandwidth part associated with the downlink message, a subcarrier spacing associated with the downlink message, or any combination thereof.

4. The network entity of claim 1, wherein the one or more processors are individually or collectively further operable to execute the code to cause the network entity to:
obtain capability information indicating that a user equipment (UE) supports the first interleaving operation; and
output control signaling enabling the first interleaving operation based at least in part on obtaining the capability information, wherein performing the first interleaving operation and outputting the downlink message is based at least in part on outputting the control signaling enabling the first interleaving operation.

5. The network entity of claim 4, wherein the capability information comprises an indication of a first threshold quantity of code blocks supported by the UE for deinterleaving the downlink message according to a deinterleaving operation corresponding to the first interleaving operation, and enabling the first interleaving operation is based at least in part on the first quantity of supported code blocks satisfying a threshold.

6. The network entity of claim 5, wherein the plurality of code blocks is based at least in part on the capability information, and a quantity of the plurality of code blocks satisfies the first threshold quantity of code blocks.

7. The network entity of claim 1, wherein the one or more processors are individually or collectively further operable to execute the code to cause the network entity to:
estimate downlink channel state information for the downlink message; and
enable the first interleaving operation based at least in part on a channel rank, a modulation and coding scheme, or both, associated with the estimated downlink channel state information.

8. The network entity of claim 1, wherein the one or more processors are individually or collectively further operable to execute the code to cause the network entity to:
obtain a request to perform the first interleaving operation based at least in part on a threshold delay spread associated with an estimated delay spread, wherein performing the first interleaving operation is based at least in part on the request.

9. The network entity of claim 1, wherein performing the first interleaving operation is based at least in part on a bandwidth allocation associated with the downlink message.

10. The network entity of claim 1, wherein the one or more processors are individually or collectively further operable to execute the code to cause the network entity to:
select a second interleaving value based at least in part on one or more unavailable resource elements of the first quantity of resource elements, the second interleaving value being lower than the first interleaving value; and
perform a third interleaving operation to interleave a third quantity of resource elements, the third quantity of resource elements corresponding to the second interleaving value, wherein each cycle of the plurality of cycles is based at least in part on the third interleaving operation.

11. The network entity of claim 1, wherein the one or more processors are individually or collectively further operable to execute the code to cause the network entity to:
select a second interleaving value based at least in part on one or more unavailable resource elements of the first quantity of resource elements, the second interleaving value equal to the first interleaving value; and
perform a third interleaving operation to interleave a third quantity of resource elements, the third quantity of resource elements corresponding to the second interleaving value, wherein each cycle of the plurality of cycles is based at least in part on the third interleaving operation.

12. A user equipment (UE), comprising:
one or more memories storing processor-executable code; and
one or more processors coupled with the one or more memories and individually or collectively operable to execute the code to cause the UE to:
obtain a downlink message;
perform a first deinterleaving operation to deinterleave the downlink message into a plurality of cycles;
perform a second deinterleaving operation to deinterleave each cycle of the plurality of cycles into a respective code block of a plurality of code blocks according to a first interleaving value, wherein each cycle of the plurality of cycles comprises at least a first quantity of resource elements corresponding to the first interleaving value; and
decode the downlink message based at least in part on the first deinterleaving operation and the second deinterleaving operation.

13. The UE of claim 12, wherein the one or more processors are individually or collectively further operable to execute the code to cause the UE to:
obtain an indication of the first interleaving value, wherein performing the second deinterleaving operation is based at least in part on obtaining the indication of the first interleaving value.

14. The UE of claim 12, wherein the one or more processors are individually or collectively further operable to execute the code to cause the UE to:
output capability information indicating that the UE supports the second deinterleaving operation; and
obtain control signaling enabling the second deinterleaving operation based at least in part on outputting the capability information, wherein obtaining the downlink message and performing the second deinterleaving operation is based at least in part on obtaining the control signaling enabling the second deinterleaving operation.

15. The UE of claim 14, wherein the capability information comprises an indication of a first threshold quantity of code blocks supported by the UE for deinterleaving the downlink message according to the second deinterleaving operation, and enabling the second deinterleaving operation is based at least in part on the first quantity of supported code blocks satisfying a threshold.

16. The UE of claim 12, wherein the one or more processors are individually or collectively further operable to execute the code to cause the UE to:
obtain control signaling enabling the second deinterleaving operation based at least in part on a channel rank, a modulation and coding scheme, or both, associated with an estimated downlink channel state information.

17. The UE of claim 12, wherein the one or more processors are individually or collectively further operable to execute the code to cause the UE to:
communicate, via radio resource control signaling or downlink control information signaling, an indication of a threshold quantity of code blocks for the second deinterleaving operation, wherein performing the second deinterleaving operation is based at least in part on the plurality of code blocks satisfying the threshold quantity of code blocks.

18. The UE of claim 12, wherein the one or more processors are individually or collectively further operable to execute the code to cause the UE to:
output a request for the downlink message according to an interleaving operation corresponding to the second deinterleaving operation based at least in part on a threshold delay spread associated with an estimated delay spread, wherein performing the second deinterleaving operation is based at least in part on outputting the request.

19. The UE of claim 12, wherein the one or more processors are individually or collectively further operable to execute the code to cause the UE to:
obtain control signaling enabling the second deinterleaving operation, wherein performing the second deinterleaving operation is based at least in part on a bandwidth allocation associated with the downlink message.

20. The UE of claim 12, wherein the one or more processors are individually or collectively further operable to execute the code to cause the UE to:
perform a third deinterleaving operation to deinterleave the plurality of code blocks according to a second interleaving value that is lower than the first interleaving value, wherein each cycle of the plurality of cycles is based at least in part on the third deinterleaving operation.

21. The UE of claim 12, wherein the one or more processors are individually or collectively further operable to execute the code to cause the UE to:
perform a third deinterleaving operation to deinterleave the plurality of code blocks according to a second interleaving value equal to the first interleaving value, wherein each cycle of the plurality of cycles is based at least in part on the third deinterleaving operation.

22. A method for wireless communications at a network entity, comprising:
performing a first interleaving operation to interleave a first quantity of resource elements of each respective code block of a plurality of code blocks into a respective cycle of a plurality of cycles, the first quantity of resource elements corresponding to a first interleaving value;
performing a second interleaving operation to interleave each cycle of the plurality of cycles with a second quantity of resource elements corresponding to a second plurality of code blocks; and
outputting a downlink message based at least in part on the first interleaving operation and the second interleaving operation.

23. The method of claim 22, further comprising:
outputting an indication of the first interleaving value, wherein outputting the downlink message is based at least in part on outputting the indication of the first interleaving value.

24. The method of claim 23, wherein outputting the indication of the first interleaving value further comprises:
selecting the first interleaving value from a plurality of candidate interleaving values based at least in part on one or more of: a carrier frequency associated with the downlink message, a bandwidth part associated with the downlink message, a subcarrier spacing associated with the downlink message, or any combination thereof.

25. The method of claim 22, further comprising:
obtaining capability information indicating that a user equipment (UE) supports the first interleaving operation; and
outputting control signaling enabling the first interleaving operation based at least in part on obtaining the capability information, wherein performing the first interleaving operation and outputting the downlink message is based at least in part on outputting the control signaling enabling the first interleaving operation.

26. The method of claim 22, further comprising:
estimating downlink channel state information for the downlink message; and
enabling the first interleaving operation based at least in part on a channel rank, a modulation and coding scheme, or both, associated with the estimated downlink channel state information.

27. The method of claim 22, further comprising:
selecting a second interleaving value based at least in part on one or more unavailable resource elements of the first quantity of resource elements, the second interleaving value being lower than the first interleaving value; and
performing a third interleaving operation to interleave a third quantity of resource elements, the third quantity of resource elements corresponding to the second interleaving value, wherein each cycle of the plurality of cycles is based at least in part on the third interleaving operation.

28. The method of claim 22, further comprising:
selecting a second interleaving value based at least in part on one or more unavailable resource elements of the first quantity of resource elements, the second interleaving value equal to the first interleaving value; and
performing a third interleaving operation to interleave a third quantity of resource elements, the third quantity of resource elements corresponding to the second interleaving value, wherein each cycle of the plurality of cycles is based at least in part on the third interleaving operation.

29. A method for wireless communications at a user equipment (UE), comprising:
obtaining a downlink message;
performing a first deinterleaving operation to deinterleave the downlink message into a plurality of cycles;
performing a second deinterleaving operation to deinterleave each cycle of the plurality of cycles into a respective code block of a plurality of code blocks according to a first interleaving value, wherein each cycle of the plurality of cycles comprises at least a first quantity of resource elements corresponding to the first interleaving value; and
decoding the downlink message based at least in part on the first deinterleaving operation and the second deinterleaving operation.

30. The method of claim 29, further comprising:
obtaining an indication of the first interleaving value, wherein
performing the second deinterleaving operation is based at least in part on obtaining the indication of the first interleaving value.
